(19) United States
(12) Patent Application Publication
(10) Pub. No.: US 2022/0404588 A1
(43) Pub. Date: Dec. 22, 2022

(54) Optical Imaging Lens Assembly

(71) Applicant: ZHEJIANG SUNNY OPTICS CO., LTD., Ningbo (CN)

(72) Inventors: Haidong XIAO, Ningbo (CN); Fujian DAI, Ningbo (CN); Liefeng ZHAO, Ningbo (CN)

(21) Appl. No.: 17/749,166

(22) Filed: May 20, 2022

(30) Foreign Application Priority Data
Jun. 9, 2021 (CN) 202110640988.8

(51) Int. Cl. G02B 13/00; G02B 9/64

(52) U.S. Cl. CPC G02B 13/0045; G02B 9/64

(57) ABSTRACT

The disclosure provides an optical imaging lens assembly, sequentially including, from an object side to an image side along an optical axis: an iris diaphragm; a first lens with a positive refractive power, an object-side surface thereof is a convex surface, and an image-side surface thereof is a concave surface; a second lens with a refractive power; a third lens with a refractive power; a fourth lens with a refractive power; a fifth lens with a refractive power: a sixth lens with refractive power; a seventh lens with a positive refractive power; and an eighth lens with a negative refractive power. EPDₘₐₓ is a maximum entrance pupil diameter of the optical imaging lens assembly, EPDₘᵢₙ is a minimum entrance pupil diameter of the optical imaging lens assembly, and EPDₘₐₓ, EPDₘᵢₙ and a total effective focal length f of the optical imaging lens assembly satisfy: f/(EPDₘₐₓ−EPDₘᵢₙ)>2.2.

### CROSS−REFERENCE TO RELATED APPLICATION

The disclosure claims priority to and the benefit of Chinese Patent Application No. 202110640988.8, filed to the China National Intellectual Property Administration (CHIPA) on 9 Jun. 2021, which is hereby incorporated by reference in its entirety.

### TECHNICAL FIELD

The disclosure relates to the technical field of the optical elements, and particularly to an optical imaging lens assembly.

### BACKGROUND

In recent years, with the development of a technology of photographing with portable electronic products such as smart phones, smart phones with high imaging quality have been increasingly favored by many consumers. However, a natural limitation of a small space of a smart phone affects the imaging quality of an optical imaging lens assembly in the smart phone in a complex light environment seriously. Therefore, how to reasonably set a refractive power, key technical parameter, etc., of an optical imaging lens assembly to improve shooting quality in a complex light environment under the condition of satisfying an existing mounting space of a mobile phone has become one of hard problems urgent to be solved by many lens manufacturers at present.

### SUMMARY

An embodiment of the disclosure provides an optical imaging lens assembly, which sequentially includes from an object side to an image side along an optical axis: an iris diaphragm; a first lens with a positive, refractive power, an object-side surface thereof is a convex surface, and an image-side surface thereof is a concave surface; a second lens with a refractive power; a third lens with a refractive power; a fourth lens with a refractive power; a fifth lens with a refractive power; a sixth lens with refractive power: a seventh lens with a positive refractive power; and an eighth lens with a negative refractive power. EPDₘₐₓ is a maximum entrance pupil diameter of the optical imaging lens assembly, EPDₘᵢₙ is a minimum entrance pupil diameter of the optical imaging lens assembly, and EPDₘₐₓ, EPDₘᵢₙ and a total effective focal length f of the optical imaging lens assembly may satisfy: f/(EPDₘₐₓ−EPDₘᵢₙ)>2.2.

In an implementation mode, at least one mirror surface in the object-side surface of the first lens to an image-side surface of the eighth lens is an aspheric mirror surface.

In an implementation mode, an effective focal length f1 of the first lens, a curvature radius R1 of the object-side surface of the first lens and a curvature radius R2 of the image-side surface of the first lens may satisfy: 0.3<f1/(R2−R1)<4.8.

In an implementation mode, a curvature radius R3 of an object-side surface of the second lens and a curvature radius R4 of an image-side surface of the second lens may satisfy: 0.8<R3/R4<2.0.

In an implementation mode, a curvature radius R13 of an object-side surface of the seventh lens, a curvature radius R14 of an image-side surface of the seventh lens and an effective focal length f7 of the seventh lens may satisfy: 0.8<(R14−R13)f7<1.5.

In an implementation mode, an effective focal length f8 of the eighth lens, a spacing distance T78 between the seventh lens and the eighth lens on the optical axis and a center thickness CT8 of the eighth lens on the optical axis may satisfy: −3.6<f8/(T78+CT8)<-3.0.

In an implementation mode, f123 is a combined focal length of the first lens, the second lens and the third lens, f67 is a combined focal length of the sixth lens and the seventh lens, and f123 and f67 satisfy: 1.2<f123/f67<1.8.

In an implementation mode, f45 is a combined focal length of the fourth lens and the fifth lens, a curvature radius R7 of an object-side surface of the fourth lens, a curvature radius R8 of an image-side surface of the fourth lens, a curvature radius R9 of an object-side of the fifth lens, a curvature radius R10 of an image-side surface of the fifth lens and f45 may satisfy: −2.0<f45/(R7+R8+R94−R10)<-0.2.

In an implementation mode, a center thickness CT1 of the first lens on the optical axis, a center thickness CT2 of the second lens on the optical axis, a center thickness CT3 of the third lens on the optical axis, an edge thickness ET1 of the first lens, an edge thickness ET2 of the second lens and an edge thickness ET3 of the third lens may satisfy: 1.5<(CT1+CT2+CT3)/(ET1+ET2+ET3)<2.0.

In an implementation mode, an edge thickness ET4 of the fourth lens, an edge thickness ET5 of the fifth lens and an edge thickness ET6 of the sixth lens may satisfy: 1.0<(ET4+ET5)/ET6<2.0.

In an implementation mode, SAG71 is a distance from an intersection point of an object-side surface of the seventh lens and the optical axis to an effective radius vertex of the object-side surface of the seventh lens on the optical axis, SAG72 is a distance from an intersection point of an image-side surface of the seventh lens and the optical axis to an effective radius vertex of the image-side surface of the seventh lens on the optical axis, and SAG_{71,} SAG72 and an edge thickness ET7 of the seventh lens may satisfy: −2.8<(SAG71+SAG72)/ET7<-1.6.

In an implementation mode, SAG81 is a distance from an intersection point of an object-side surface of the eighth lens and the optical axis to an effective radius vertex of the object-side surface of the eighth lens on the optical axis, SAG82 is a distance from an intersection point of an image-side surface of the eighth lens and the optical axis to an effective radius vertex of the image-side surface of the eighth lens on the optical axis, and SAG81 and SAG82 may satisfy: 1.2<SAG81/SAG82<1.9.

In an implementation mode, EPDₘₐₓ is the maximum entrance pupil diameter of the optical imaging lens assembly, EPDₘᵢₙ is the minimum entrance pupil diameter of the optical imaging lens assembly, and EPDₘₐₓ and EPDₘᵢₙ may satisfy: 1.1<EPDₘₐₓ/EPDₘᵢₙ<3.1.

In an implementation mode, EPDₘₐₓ is the maximum entrance pupil diameter of the optical imaging lens assembly, EPDₘᵢₙ is the minimum entrance pupil diameter of the optical imaging lens assembly, and EPDₘₐₓ and , EPDₘᵢₙ and the total effective focal length f of the optical imaging lens assembly may satisfy: 2.2<f/(EPDₘₐₓ−EPDₘᵢₙ)<20.

In an implementation mode, an object-side surface of the sixth lens is a convex surface, and an image-side surface of the sixth lens is a concave surface; an object-side surface of the seventh lens is a convex surface, and an image-side surface of the, seventh lens is a concave surface.

Another embodiment of the disclosure provides an optical imaging lens assembly, which sequentially includes from an abject side to an image side along an optical axis: an iris diaphragm; a first lens with a positive refractive power, an object-side surface thereof is a convex surface, and an image-side surface thereof is a concave surface; a second lens with a refractive power; a third lens with a refractive power; a fourth lens with a retractive power; a fifth lens with a refractive power; a sixth lens with refractive power; a seventh lens with a positive refractive power; and an eighth lens with a negative refractive power. The optical imaging lens assembly may satisfy: 1.2<f123/f67<1.8, wherein f123 is a combined focal length of the first lens, the second lens and the third lens, and f67 is a combined focal length of the sixth lens and the seventh lens.

In an implementation mode, an effective focal length f1 of the first lens, a curvature radius R1 of the object-side surface of the first lens and a curvature radius R2 of the image-side surface of the first lens may satisfy: 0.3<f1/(R2−R1)<4.8.

In an implementation mode, a curvature radius R3 of an object-side surface of the second lens and a curvature radius R4 of an image-side surface of the second lens may satisfy: 0.8<R3/R4<2.0.

In an implementation mode, a curvature radius R13 of an object-side surface of the seventh lens, a curvature radius R14 of an image-side surface of the seventh lens and an effective focal length f7 of the seventh, lens may satisfy: 0.8<(R14−R13)f7<1.5.

In an implementation mode, an effective focal length f8 of the eighth lens, a spacing distance T78 between the seventh lens and the eighth lens on the optical axis and a center thickness CT8 of the eighth lens on the optical axis may satisfy: −3.6<f8/(T78+CT8)<-3.0.

In an implementation mode, f45 is a combined focal length of the fourth lens and the fifth lens, a curvature radius R7 of an object-side surface of the fourth lens, a curvature radius R8 of an image-side surface of the fourth lens, a curvature radius R9 of an object-side of the fifth lens, a curvature radius R10 of an image-side surface of the fifth lens and f45 may satisfy: −2.0<f45/(R7+R8+R9+R10)<-0.2.

In an implementation mode, a center thickness CT1 of the first lens on the optical axis, a center thickness CT2 of the second lens on the optical axis, a center thickness CT3 of the third lens on the optical axis, an edge thickness ET1 of the first lens, an edge thickness ET2 of the second lens and an edge thickness ET3 of the third lens may satisfy: 1.5<(CT1+CT2+CT3)/(ET1+ET2+ET3)<2.0.

In an implementation mode, an edge thickness ET4 of the fourth lens, an edge thickness ET5 of the fifth lens and an edge thickness ET6 of the sixth lens may satisfy: 1.0<(ET-4+ET5)/ET6<2.0.

In an implementation mode, SAG71 is a distance from an intersection point of an object-side surface of the seventh lens and the optical axis to an effective radius vertex of the object-side surface of the seventh lens on the optical axis, SAG72 is a distance from an intersection point of an image-side surface of the seventh lens and the optical axis to an effective radius vertex of the image-side surface of the seventh lens on the optical axis, and SAG71, SAG72 and an edge thickness ET7 of the seventh lens may satisfy: −2 8<(SAG71+SAG72)/ET7<-1.6.

In an implementation mode, SAG81 is a distance from an intersection point of an object-side surface of the eighth lens and the optical axis to an effective radius vertex of the object-side surface of the eighth lens on the optical axis, SAG82 is a distance from an intersection point of an image-side surface of the eighth lens and the optical axis to an effective radius vertex of the image-side surface of the eighth, lens on the optical axis, and SAG81 and SAG82 may satisfy: 1.2<SAG81/SAG82<1.9.

In an implementation mode, EPDₘₐₓ is a maximum entrance pupil diameter of the optical imaging lens assembly, EPDₘᵢₙ is a minimum entrance pupil diameter of the optical imaging lens assembly, and EPDₘₐₓ and EPDₘᵢₙ may satisfy: 1.1<EPDₘₐₓ/EPDₘᵢₙ<3.1.

In an implementation mode, EPDₘₐₓ is a maximum entrance pupil diameter of the optical imaging lens assembly EPDₘᵢₙ is a minimum entrance pupil diameter of the optical imaging lens assembly, f is a total effective focal length of the optical imaging lens assembly, and EPDₘₐₓ, EPDₘᵢₙ and f may satisfy: 2.2<f/(EPDₘₐₓ−EPDₘᵢₙ)<20.

In an implementation mode, an object-side surface of the sixth lens is a convex surface, and an image-side surface is a concave surface. An object-side surface of the seventh lens is a convex surface, and an image-side surface is a concave surface.

According to the disclosure, the refractive power is configured reasonably, and optical parameters are optimized, so that the provided optical imaging lens assembly is applicable to a portable electronic product, and has at least one of beneficial effects of small size, large image surface, variable aperture, high imaging quality, etc.

### BRIEF DESCRIPTION OF THE DRAWINGS

The other features, objectives and advantages of the disclosure become more apparent upon reading detailed descriptions made to unrestrictive embodiments with reference to the following drawings.

FIGS. 1A and 1B show structural schematic diagrams of an optical imaging lens assembly when an aperture value is 1.47 and 2.06 according to Embodiment 1 of the disclosure respectively;

FIGS. 2A and 2B show an astigmatism curve and a distortion curve of an optical imaging lens assembly when an aperture value is 1.47 according to Embodiment 1 respectively;

FIGS. 2C and 2D show an astigmatism curve and a distortion curve of an optical imaging lens assembly when an aperture value is 2.05 according to Embodiment 1 respectively:

FIGS. 3A and 3B show structural schematic diagrams of an optical imaging lens assembly when an aperture value is 1.46 and 2.05 according to Embodiment 2 of the disclosure respectively;

FIGS. 4A and 4B show an astigmatism curve and a distortion curve of an optical imaging lens assembly when an aperture value is 1.46 according to Embodiment 2 respectively;

FIGS. 4C and 4D show an astigmatism curve and a distortion curve of an optical imaging lens assembly when an aperture value is 2.05 according to Embodiment 2 respectively;

FIGS. 5A and 5B show structural schematic diagrams of an optical imaging lens assembly when an aperture value is 1.46 and 2.05 according to Embodiment 3 of the disclosure respectively;

FIGS. 6A and 6B show an astigmatism curve and a distortion curve of an optical imaging lens assembly when an aperture value is 1.46 according to Embodiment 3 respectively;

FIGS. 6C and 6D show an astigmatism curve and a distortion curve of an optical imaging lens assembly when an aperture value is 2.05 according to Embodiment 3 respectively;

FIGS. 7A and 7B are structural schematic diagrams of an optical imaging lens assembly when an aperture value is 1.46 and 2.05 according to Embodiment 4 of the disclosure respectively;

FIGS. 8A and 8B show an astigmatism curve and a distortion curve of an optical imaging lens assembly when an aperture value is 1.46 according to Embodiment 4 respectively;

FIGS. 8C and 8D show an astigmatism curve and a distortion curve of an optical imaging lens assembly when an aperture value is 2.05 according to Embodiment 4 respectively;

FIGS. 9A and 9B are structural schematic diagrams of an optical imaging lens assembly when an aperture value is 1.47 and 2.05 according to Embodiment 5 of the disclosure respectively;

FIGS. 10A and 10B show an astigmatism curve and a distortion curve of an optical imaging lens assembly when an aperture value is 1.47 according to Embodiment 5 respectively;

FIGS. 10C and 10D show an astigmatism curve and a distortion curve of an optical imaging lens assembly when an aperture value is 2.05 according to Embodiment 5 respectively;

FIGS. 11A and 11B are structural schematic diagrams of an optical imaging lens assembly when an aperture value is 1.46 and 4.00 according to Embodiment 6 of the disclosure respectively;

FIGS. 12A and 12B show an astigmatism curve and a distortion curve of an optical imaging lens assembly when an aperture value is 1.46 according to Embodiment 6 respectively; and

FIGS. 12C and 12D show an astigmatism curve and a distortion curve of an optical imaging lens assembly when an aperture value is 4.00 according to Embodiment 6 respectively,

### DETAILED DESCRIPTION OF THE EMBODIMENTS

In order to understand the disclosure better, more detailed descriptions will be made to each aspect of the disclosure with reference to the drawings, It is to be understood that these detailed descriptions are only descriptions about the exemplary embodiments of the disclosure and not intended to limit the scope of the disclosure in any manner. In the whole specification, the same reference sign numbers represent the same components. Expression “and/or” includes any or all combinations of one or more in associated items that are listed.

It is to be noted that, in this description, expressions first, second, third and the like are only used to distinguish one feature from another feature and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings, The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It is also to be understood that terms “include”, “including”, “have”, “contain”, and/or “containing”, used in the specification, represent existence of a stated feature, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the embodiments of the disclosure are described, “may” is used to represent “one or more embodiments of the disclosure”. Furthermore, term “exemplary” refers to an example or exemplary description.

Unless otherwise defined, all terms (including technical terms and scientific terms) used in the disclosure have the same meanings as commonly understood by those of ordinary skill in the art of the disclosure. It is also to be understood that the terms (for example, terms defined in a common dictionary) should be explained to have, the same meanings as those in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail.

The features, principles and other aspects of the disclosure will be described below in detail.

An optical imaging lens assembly according to an exemplary embodiment of the disclosure may include eight lenses with refractive powers, i.e., a first, lens, a second lens, a third lens, a fourth lens, a fifth lens, a sixth lens, a seventh lens and an eighth lens respectively. The, eight lenses are sequentially arranged from an object side to an image side along an optical axis. There may be a spacing distance between any two adjacent lenses in the first lens to the eighth lens.

According to an exemplary embodiment of the disclosure, the first lens may have a positive refractive power, and an object-side surface thereof may be a convex surface, and an image-side surface thereof may be a concave surface; the second lens may have a positive refractive power or a negative refractive power; the third lens may have a positive refractive power or a negative refractive power; the fourth lens may have a positive refractive power or a negative refractive power; the fifth lens may have a positive refractive power or a negative refractive power; the sixth lens may have a positive refractive power or a negative refractive power, the seventh lens may have a positive refractive power; and the eighth lens may have a negative refractive power.

In an exemplary embodiment, the first lens has a positive refractive power, which contributes to converging rays rapidly to restrain a clear aperture of the lens assembly. The seventh lens has a positive refractive power, which contributes to converging rays in an internal field of view of the lens assembly to correct a paraxial aberration. The eighth lens has a negative refractive power, which contributes to converging rays in an external field of view of the, lens assembly to correct an aberration in the external field of view.

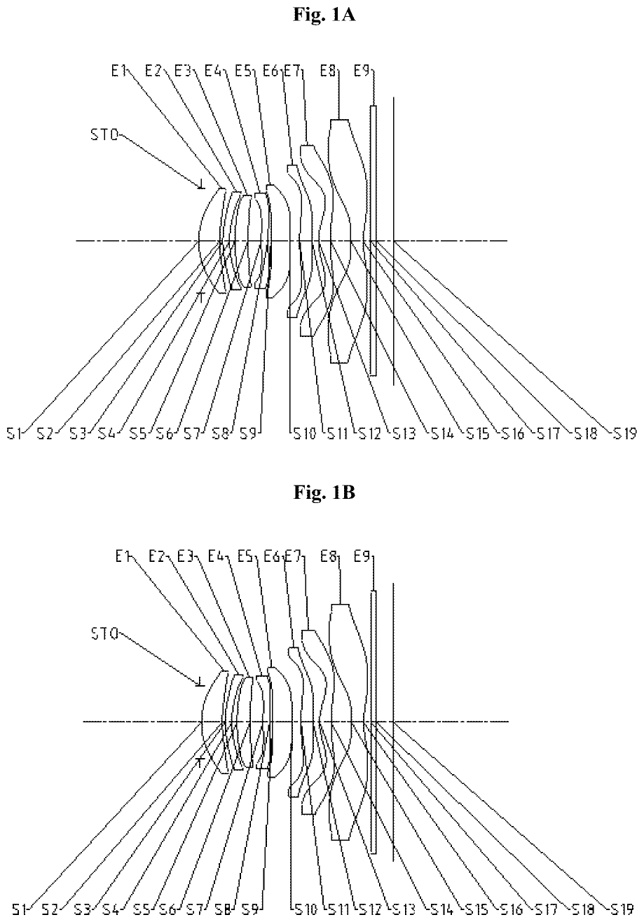

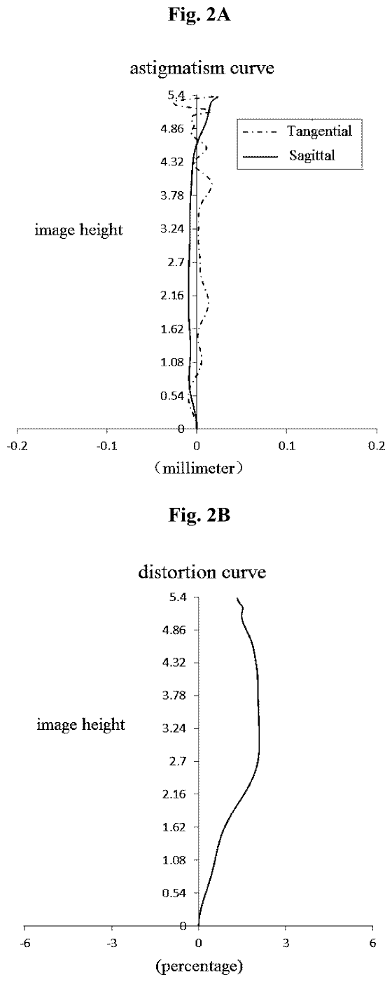

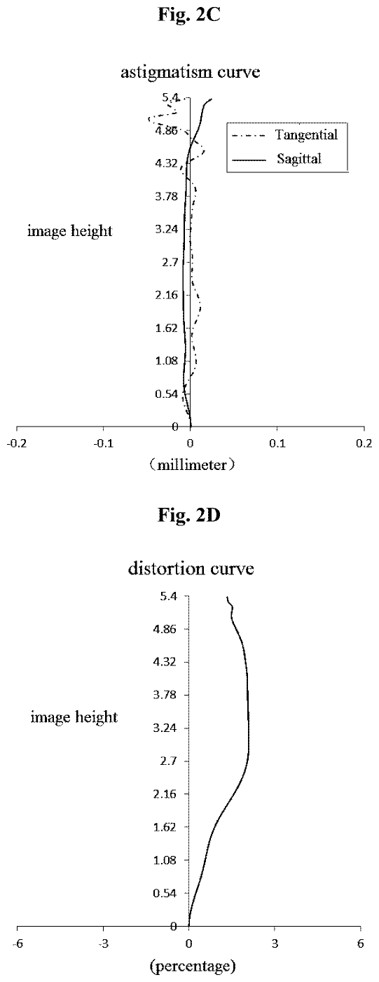

In an exemplary embodiment, the optical imaging lens assembly according to the disclosure further includes an iris diaphragm arranged between the object side and the first lens. Specifically, a diaphragm is variable in a direction perpendicular to the optical axis. That is, an aperture of the diaphragm is adjustable. As shown in FIGS. 1 and 2, the optical imaging lens assembly is provided with an iris diaphragm STO, so that an aperture of the iris diaphragm STO is variable, and furthermore, an effect of varying an entrance pupil diameter of the optical imaging lens assembly may be achieved, According to the disclosure, the entrance pupil diameter of the optical imaging lens assembly may be varied to achieve an effect of continuously varying an aperture value of the optical imaging lens assembly to further achieve a relatively large variation range for the aperture value of the lens assembly.

In an exemplary embodiment, the optical imaging lens assembly according to the disclosure may satisfy: f/(EPDₘₐₓ−EPDₘᵢₙ)>2.2, wherein EPDₘₐₓ is a maximum entrance pupil diameter of the optical imaging lens assembly, EPDₘᵢₙ is a minimum entrance pupil diameter of the optical imaging lens assembly, and f is a total effective focal length of the optical imaging lens assembly. More specifically, f, EPDₘₐₓ and EPDₘᵢₙ may further satisfy: 2.2<f/(EPDₘₐₓ−EPDₘᵢₙ)<20. Furthermore, f, EPDₘₐₓ and EPDₘᵢₙ may satisfy: 2.2<f/(EPDₘₐₓ−EPDₘᵢₙ)<5.5, f/(EPDₘₐₓ−EPDₘᵢₙ)>2.2 is satisfied, so that the optical imaging lens assembly has a relatively large aperture variation range and focal length variation range, and an imaging quality of the lens assembly may be improved relatively well.

In an exemplary embodiment, the optical imaging lens assembly according to the disclosure may satisfy: 0.3<f1/(R2−R1)<4.8, wherein f1 is an effective focal length of the first lens, R1 is a curvature radius of the object-side surface of the first lens, and R2 is a curvature radius of the image-side surface of the first lens. More specifically, f1, R2 and R1 may further satisfy: 0.4<f1/(R2−R1)<4.7. 0.3<f1t(R2−R1)<4.8 is satisfied, so that the refractive power of the first lens may be configured reasonably, and an aberration correction of the first lens may further be controlled effectively,

In an exemplary embodiment, the optical imaging lens assembly according to the disclosure may satisfy: 0.8<R3/R4<2.0, wherein R3 is a curvature radius of an object-side surface of the second lens, and R4 is a curvature radius of an image-side surface of the second lens. More specifically, R3 and R4 may further satisfy: 1.0<R31R4<1.9. 0.8<R3/R4<2.0 is satisfied, so that a smooth surface type of the second lens may be ensured, which contributes to achieving a relatively large aperture of the second lens and further contributes to forming and manufacturing the second lens.

In an exemplary embodiment, the optical imaging lens assembly according to the disclosure may satisfy: 0.8<(R14−R13)/f7<1.5, wherein R13 is a curvature radius of an object-side surface of the seventh lens, R14 is a curvature radius of an image-side surface of the seventh lens, and f7 is an effective focal length of the seventh lens. More specifically, R14, R13 and f7 may further satisfy: 0.9<(R14−R13)/f7<1.4. 0.8<(R14−R13)/f7<1.5 is satisfied, so that the refractive power of the seventh lens may be configured reasonably, and an aberration correction of the seventh lens may further be controlled effectively.

In an exemplary embodiment, the optical imaging lens assembly according to the disclosure may satisfy: −3.6<f8/(T78+CT8)<-3.0, wherein f8 is an effective focal length of the eighth lens, T78 is a spacing distance between the seventh lens and the eighth lens on the optical axis, and CT8 is a center thickness of the eighth lens on the optical axis, More specifically, f7, T78 and CT8 may further satisfy: −3.5<f8/(T78+CT8)<-3.2. −3.6<f8/(T78+CT8)<-3.0 is satisfied, so that a field curvature of the optical imaging lens assembly may be balanced effectively to achieve a reasonable field curvature of the optical imaging lens assembly, and meanwhile, the eighth lens may be structured uniformly and reasonably.

In an exemplary embodiment, the optical imaging lens assembly according to the disclosure may satisfy: 1.2<f123/f67<1.8, wherein f123 is a combined focal length of the first lens, the second lens and the third lens, and f67 is a combined focal length of the sixth lens and the seventh lens, More specifically, f123 and 167 may further satisfy: 1,4<f123/f67<1.7. 1.2<f123/f67<1.8 is satisfied, so that a deflection angle of a ray may be reduced, and an imaging quality of the optical imaging lens assembly may be improved.

In an exemplary embodiment, the optical imaging lens assembly according to the disclosure may satisfy: −2.0<f45/(R7+R8+R9+R10)<-0.2, wherein f45 is a combined focal length of the fourth lens and the fifth lens, R7 is a curvature radius of an object-side surface of the fourth lens, R8 is a curvature radius of an image-side surface of the fourth lens, R9 is a curvature radius of an object-side of the fifth lens, and R10 is a curvature radius of an image-side surface of the fifth lens. More specifically, f45, R7, R8, R9 and R10 may further satisfy: −2.0<f45/(R7+R8+R9+R10)<-0.4. −2.0<f451(R7+R8+R9+R10)<-0.2 is satisfied, so that a deflection angle of a ray may be reduced, and an imaging quality of the optical imaging lens assembly may be improved.

In an exemplary embodiment, the optical imaging lens assembly according to the disclosure may satisfy: 1.5<(CT1+CT2+CT3)/(ET1+ET2+ET3)<2.0, wherein CT1 is a center thickness of the first lens on the optical axis, CT2 is a center thickness of the second lens on the optical axis, CT3 is a center thickness of the third lens on the optical axis, ET1 is an edge thickness of the first lens, ET2 is an edge thickness of the second lens, and ET3 is an edge thickness of the third lens. More specifically, CT1, CT2, CT3, ET1, ET2 and ET3 may further satisfy: 1.6<(CT1+CT2+CT3)/(ET1+ET2+ET3)<1.9. 1.5<(CT1+CT2+CT3)/(ET1+ET2+ET3)<2.0 is satisfied, so that a field curvature of the optical imaging lens assembly may be balanced effectively to achieve a reasonable field curvature of the optical imaging lens assembly, and meanwhile, the first lens, the second lens and the third lens may be structured uniformly and reasonably, which contributes to forming the first lens, the second lens, and the third lens.

In an exemplary embodiment, the optical imaging lens assembly according to the disclosure may satisfy: 1.0<(ET4+ET5)ET6<2.0, wherein ET4t is an edge thickness of the fourth lens, ET5 is an edge thickness of the fifth lens, and ET6 is an edge thickness of the sixth lens. 1.0<(ET4+ET5)/ET6<2.0 is satisfied, so that the fourth lens, the fifth lens and the sixth lens may be structured uniformly and reasonably, which contributes to forming the fourth lens, the fifth lens, and the sixth lens.

In an exemplary embodiment, the optical imaging lens assembly according to the disclosure may satisfy: −2.8<(SAG71+SAG72)/ET7<-1.6, wherein SAG71 is a distance from an intersection point of an object-side surface of the seventh lens and the optical axis to an effective radius vertex of the object-side surface of the seventh lens on the optical axis, SAG72 is a distance from an intersection point of an image-side surface of the seventh lens and the optical axis to an effective radius vertex of the image-side surface of the seventh lens on the optical axis, and ET7 is an edge thickness of the seventh lens. More specifically, SAG71, SAG72 and ET7 may further satisfy: −2.7<(SAG71+SAG72)/ET7<-1.7. −2.8<(SAG71+SAG72)/ET7<-1.6 is satisfied, so that a thickness ratio of the seventh lens may be restricted effectively, which contributes to reducing a structural sensitivity of the seventh lens and a forming and demoulding of the seventh lens.

In an exemplary embodiment, the optical it aging lens assembly according to the disclosure may satisfy: 1.2<SAG81/SAG82<1.9, wherein SAG81 is a distance from an intersection point of an object-side surface of the eighth lens and the optical axis to an effective radius vertex of the object-side surface of the eighth lens on the optical axis, and SAG82 is a distance from an intersection point of an image-side surface of the eighth lens and the optical axis to an effective radius vertex of the image-side surface of the eighth lens on the optical axis. 1.2<SAG81/SAG82<1.9 is satisfied, so that a thickness ratio of the eighth lens may be restricted effectively, which contributes to reducing a structural sensitivity of the eighth lens and a forming and demoulding of the eighth lens.

In an exemplary embodiment, the optical imaging lens assembly according to the disclosure may satisfy: 1.1<EPDₘₐₓ/EPDₘᵢₙ<3.1, wherein EPDₘₐₓ is a maximum entrance pupil diameter of the optical imaging lens assembly, and EPDₘᵢₙ is a minimum entrance pupil diameter of the optical imaging lens assembly. More specifically, EPDₘₐₓ and EPDₘᵢₙ may further satisfy: 1.3<EPDₘₐₓ/EPDₘᵢₙ<2.9, 1.1<EPDₘₐₓ/EPDₘᵢₙ<3.1 is satisfied, so that a relatively large aperture variation range of the optical imaging lens assembly is reflected. In an embodiment, a maximum aperture of the optical imaging lens assembly may reach F#1.4, while a minimum aperture may reach F#4.0 or above. This contributes to achieving a seamless connection from extremely dark, to extremely bright environments.

In an exemplary embodiment, an object-side surface of the sixth lens is a convex surface, and an image-side surface of the sixth lens is a concave surface; an object-side surface of the seventh lens is a convex surface, and an image-side surface of the seventh lens is a concave surface. Surface types of the sixth lens and the seventh lens are set reasonably to help to distribute refractive powers of the sixth lens and the seventh lens reasonably, reduce a deflection angle of a ray, and improve an imaging quality of the optical imaging lens assembly.

In an embodiment, the optical imaging lens assembly may further include an optical filter configured to correct a chromatic aberration and/or a protective glass configured to protect a photosensitive element on the imaging surface. The disclosure provides an optical imaging lens assembly with the characteristics of small size, large image surface, variable aperture, high imaging quality, etc. The optical imaging lens assembly provided in the disclosure may not only achieve a higher luminous flux in a dark environment to enhance the image quality, but also avoid adverse impacts of overexposure, etc., in a bright environment. The optical imaging lens assembly, according to the embodiment of the disclosure may adopt multiple lenses, for example, the above-mentioned eight. The refractive power, surface type and material of each lens, the center thickness of each lens, on-axis spacing distances between the lenses and the like may be configured reasonably to converge incident rays effectively, reduce, an optical total length of the imaging lens assembly, improve a machinability of the imaging lens assembly and ensure that the optical imaging lens assembly is more favorable for production and machining.

In an exemplary embodiment, at least one of mirror surfaces of each lens is an aspheric mirror surface, namely at least one mirror surface in an object-side surface of the first lens to an image-side surface of the eighth lens is an aspheric mirror surface. An aspheric lens has a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatic aberrations. With the adoption of the aspheric lens, astigmatism aberrations during imaging may be eliminated as much as possible, thereby improving the imaging quality. In an embodiment, at least one of the object-side surface and the image-side surface of each lens in the first lens, the second lens, the third lens, the fourth lens, the fifth lens, the sixth lens, the seventh lens and the eighth lens is an aspheric mirror surface. In another embodiment, both the object-side surface and the image-side surface of each lens in the first lens, the second lens, the third lens, the fourth lens, the fifth lens, the sixth lens, the seventh lens and the eighth lens are aspheric mirror surfaces.

However, it is to be understood by those skilled in the art that the number of the lenses forming the optical imaging lens assembly may be changed without departing from the technical solutions claimed in the disclosure to achieve each result and advantage described in the specification. For example, although descriptions are made in the embodiment with eight lenses as an example, the optical imaging lens assembly is not limited to eight lenses. If necessary, the optical imaging lens assembly may include another number of lenses.

Specific embodiments applicable to the optical imaging lens assembly of the above-mentioned embodiment will further be described below with reference to the drawings.

### Embodiment 1

An optical imaging lens assembly according to Embodiment 1 of the disclosure will be described below with reference to FIGS. 1A-2D. FIGS. 1A and 1B show structural schematic diagrams of an optical imaging lens assembly when an aperture value is 1.47 and 2.05 according to Embodiment 1 of the disclosure respectively.

As shown in FIGS. 1A and 1B, the optical imaging lens assembly sequentially includes from an object side to an image side: an iris diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a positive retractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an abject sequentially penetrates through each of the surfaces S1 to S18 and is finally imaged on the imaging surface S19.

Table 1 shows a basic parameter table of the optical imaging lens assembly of Embodiment 1 wherein units of the curvature radius, the thickness/distance and the focal length are all millimeters (mm).

TABLE 1

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0800 | | | | |
| S1 | Aspheric | 2.7137 | 0.7809 | 1.55 | 56.1 | 9.97 | 0.1330 |
| S2 | Aspheric | 4.8624 | 0.1125 | | | | 1.2924 |
| S3 | Aspheric | 3.3465 | 0.2500 | 1.67 | 19.2 | 300681.46 | −1.3966 |
| S4 | Aspheric | 3.2456 | 0.1994 | | | | 0.0000 |
| S5 | Aspheric | 5.8927 | 0.4885 | 1.55 | 56.1 | 25.62 | 3.2433 |
| S6 | Aspheric | 9.8842 | 0.4944 | | | | −15.0640 |
| S7 | Aspheric | 18.2022 | 0.2500 | 1.64 | 23.5 | −18.62 | 0.0000 |
| S8 | Aspheric | 7.1948 | 0.1101 | | | | 7.2461 |
| S9 | Aspheric | 12.2828 | 0.7174 | 1.55 | 56.1 | 54.76 | 0.0000 |
| S10 | Aspheric | 20.4183 | 0.3520 | | | | −45.1907 |
| S11 | Aspheric | 6.3401 | 0.4533 | 1.55 | 56.1 | 629.87 | −2.1084 |
| S12 | Aspheric | 6.2961 | 0.2518 | | | | −28.1569 |
| S13 | Aspheric | 2.0825 | 0.4365 | 1.55 | 56.1 | 4.93 | −0.9188 |
| S14 | Aspheric | 8.5340 | 0.7635 | | | | 0.4188 |
| S15 | Aspheric | −94.1799 | 0.4571 | 1.54 | 55.7 | −4.05 | 0.0000 |
| S16 | Aspheric | 2.2319 | 0.2825 | | | | −1.1165 |
| S17 | Spherical | Infinite | 0.2100 | 1.52 | 64.2 | | |
| S18 | Spherical | Infinite | 0.6304 | | | | |
| S19 | Spherical | Infinite | | | | | |

In the embodiment, f is a total effective focal length of the optical imaging lens assembly, and f is 5.75 mm. TTL is a total length of the optical imaging lens assembly (i.e., a distance from the object-side surface S1 of the first lens E1 to the imaging surface S19 of the optical imaging lens assembly on the optical axis), and TTL is 7.24 mm. ImgH is a half of a diagonal length of an effective pixel region on the imaging surface S19 of the optical imaging lens assembly, and ImgH is 5.38 mm. FNOₘᵢₙ is a minimum value of an F-number of the optical imaging lens assembly, and FNOₘᵢₙ is 1.47. FNOₘₐₓ is a maximum value of the F-number of the optical imaging lens assembly, and FNOₘₐₓ is 2.05. A relative aperture of the optical imaging lens assembly is maximum when the F-number is the minimum value. The relative aperture of the optical imaging lens assembly is minimum when the F-number is the maximum value.

In Embodiment 1, both the object-side surface and the image-side surface of any lens in the first lens E1 to the eighth lens E8 are aspheric surfaces, and a surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + \sum {Aih}^{i} \qquad ( 1 )$$

wherein x is a vector height of a distance between the aspheric surface and a vertex of the aspheric surface when the aspheric, surface is located at a position with the height h in an optical axis direction; c is a paraxial curvature of the aspheric surface, c=1/R (namely, the paraxial curvature c is a reciprocal of the curvature radius R in Table 1 above); k is a conic coefficient: and Ai is a correction coefficient of the i-th order of the aspheric surface. Tables 2-1 and 2-2 show higher-order coefficients A4, A6, A8, A10, A12, A14, A16, A18, A20, A22, A24, A26, A28, and A30 that may be used for each of the aspheric mirror surfaces S1-S16 in Embodiment 1.

TABLE 2-1

| Surface | | | | | | | |
|---|---|---|---|---|---|---|---|
| number | A4 | A6 | A8 | A10 | A12 | A14 | A16 |
| S1 | −2.1129E−03 | −9.9148E−04 | 2.9532E−03 | −5.1204E−03 | 4.7728E−03 | −2.8088E−03 | 1.0615E−03 |
| S2 | −2.8515E−02 | 1.2092E−02 | −6.6787E−03 | 2.0564E−03 | −3.1579E−04 | 1.3730E−04 | −1.0007E−04 |
| S3 | −3.0198E−02 | 1.0382E−02 | −2.8792E−03 | −1.2175E−03 | 1.0380E−03 | 2.0080E−04 | −3.2405E−04 |
| S4 | −1.4993E−02 | 1.4619E−03 | −1.3460E−03 | 4.8258E−03 | −7.7980E−03 | 5.8387E−03 | −2.1752E−03 |
| S5 | −9.4800E−03 | 1.7212E−02 | −4.0074E−02 | 5.4056E−02 | −4.4215E−02 | 2.1918E−02 | −6.2355E−03 |
| S6 | −2.1433E−03 | −1.2552E−02 | 3.6415E−02 | −6.4314E−02 | 6.6849E−02 | −4.2055E−02 | 1.5850E−02 |
| S7 | −2.6135E−02 | −1.6131E−02 | 4.0183E−02 | −7.0314E−02 | 6.9854E−02 | −4.5384E−02 | 1.9350E−02 |
| S8 | −6.0135E−02 | 4.3387E−02 | −3.7971E−02 | 1.8857E−02 | −5.4597E−03 | 1.1554E−03 | −3.0202E−04 |
| S9 | −7.4906E−02 | 6.6412E−02 | −6.9561E−02 | 5.1584E−02 | −2.4827E−02 | 8.0398E−03 | −1.6384E−03 |
| S10 | −5.0744E−02 | 1.2239E−02 | 8.5558E−03 | −3.0997E−02 | 3.0736E−02 | −1.6440E−02 | 5.3024E−03 |
| S11 | −1.7237E−02 | −6.0836E−02 | 1.6872E−01 | −2.1692E−01 | 1.7088E−01 | −9.1551E−02 | 3.4884E−02 |
| S12 | −7.4668E−02 | −7.7210E−02 | 2.0938E−01 | −2.1946E−01 | 1.3925E−01 | −5.9179E−02 | 1.7467E−02 |
| S13 | −2.2527E−02 | −9.8977E−02 | 1.1897E−01 | −8.7023E−02 | 4.3859E−02 | −1.5923E−02 | 4.2130E−03 |
| S14 | 6.2444E−02 | −8.7419E−02 | 4.8612E−02 | −1.1954E−02 | −1.1461E−03 | 1.8102E−03 | −6.4302E−04 |
| S15 | −1.5840E−01 | 5.7801E−02 | −1.2062E−03 | −6.2411E−03 | 2.6189E−03 | −5.8833E−04 | 8.6159E−05 |
| S16 | −1.6498E−01 | 8.1594E−02 | −2.8066E−02 | 7.0909E−03 | −1.3891E−03 | 2.1463E−04 | −2.5898E−05 |

TABLE 2-2

| Surface | | | | | | | |
|---|---|---|---|---|---|---|---|
| number | A18 | A20 | A22 | A24 | A26 | A28 | A30 |
| S1 | −2.5264E−04 | 3.4638E−05 | −2.0855E−06 | 0.0000E−00 | 0.0000E−00 | 0.0000E−00 | 0.0000E−00 |
| S2 | 3.0861E−05 | −3.2993E−06 | 0.0000E−00 | 0.0000E−00 | 0.0000E−00 | 0.0000E−00 | 0.0000E−00 |
| S3 | 9.5634E−05 | −9.3569E−06 | 0.0000E−00 | 0.0000E−00 | 0.0000E−00 | 0.0000E−00 | 0.0000E−00 |
| S4 | 4.0019E−04 | −2.9609E−05 | 0.0000E−00 | 0.0000E−00 | 0.0000E−00 | 0.0000E−00 | 0.0000E−00 |
| S5 | 9.2846E−04 | −5.5235E−05 | 0.0000E−00 | 0.0000E−00 | 0.0000E−00 | 0.0000E−00 | 0.0000E−00 |
| S6 | −3.2831E−03 | 2.8803E−04 | 0.0000E−00 | 0.0000E−00 | 0.0000E−00 | 0.0000E−00 | 0.0000E−00 |
| S7 | −5.1540E−03 | 7.6754E−04 | −4.7893E−05 | 0.0000E−00 | 0.0000E−00 | 0.0000E−00 | 0.0000E−00 |
| S8 | 6.8227E−05 | −6.1844E−06 | 0.0000E−00 | 0.0000E−00 | 0.0000E−00 | 0.0000E−00 | 0.0000E−00 |
| S9 | 1.0298E−04 | 3.8958E−05 | −9.3036E−06 | 6.0084E−07 | 0.0000E−00 | 0.0000E−00 | 0.0000E−00 |
| S10 | −1.0327E−03 | 1.1188E−04 | −5.1675E−06 | 0.0000E−00 | 0.0000E−00 | 0.0000E−00 | 0.0000E−00 |
| S11 | −9.6312E−03 | 1.9315E−03 | −2.7791E−04 | 2.7819E−05 | −1.8264E−06 | 7.0000E−08 | −1.1707E−09 |
| S12 | −3.6188E−03 | 5.2354E−04 | −5.1723E−05 | 3.3229E−06 | −1.2504E−07 | 2.0910E−09 | 0.0000E−00 |
| S13 | −8.1192E−04 | 1.1335E−04 | −1.1321E−05 | 7.8850E−07 | −3.6418E−08 | 1.0042E−09 | −1.2540E−11 |
| S14 | 1.3389E−04 | −1.8589E−05 | 1.7763E−06 | −1.1584E−07 | 4.9345E−09 | −1.2388E−10 | 1.3906E−12 |
| S15 | −8.7519E−06 | 6.3056E−07 | −3.2228E−08 | 1.1448E−09 | −2.6911E−11 | 3.7669E−13 | −2.3780E−15 |
| S16 | 2.3908E−06 | −1.6507E−07 | 8.3091E−09 | −2.9438E−10 | 6.9322E−12 | −9.7196E−14 | 6.1317E−16 |

FIGS. 2A and 2C show astigmatism curves of the optical imaging lens assembly according to Embodiment 1 when the aperture value is 1.47 and 2.05 respectively to represent a tangential image surface curvature and a sagittal image surface curvature. FIGS. 2B and 2D show distortion curves of the optical imaging lens assembly according to Embodiment 1 when the aperture value is 1.47 and 2.05 respectively to represent distortion values corresponding to different image heights. According to FIGS. 2A-2D, it can be seen that the optical imaging lens assembly provided in Embodiment 1 may achieve high imaging quality.

Embodiment 2

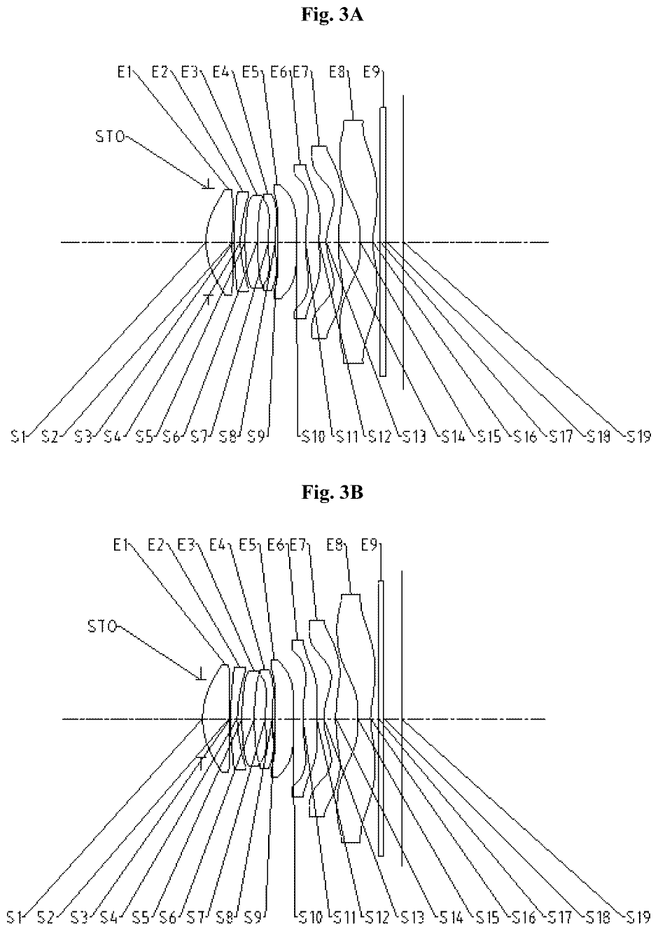

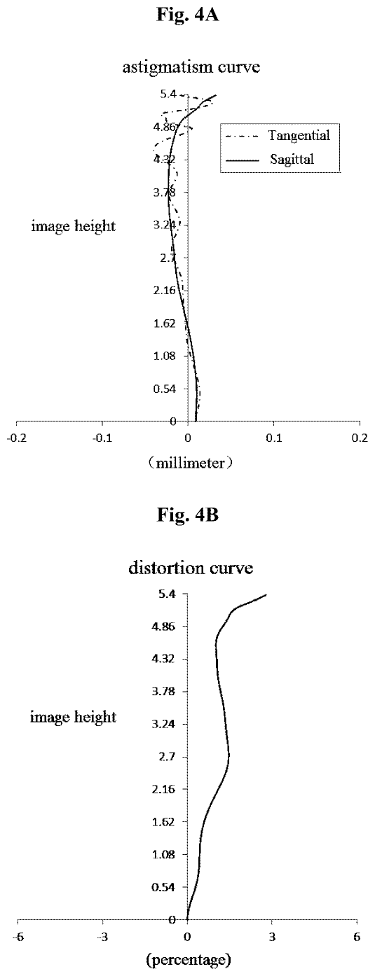

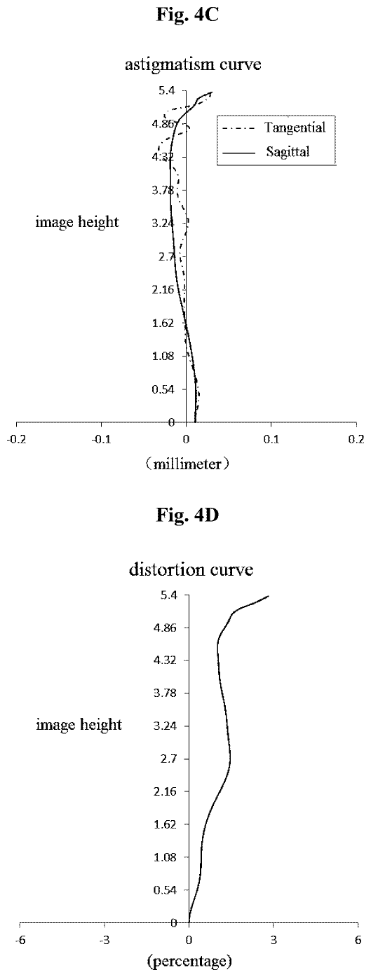

An optical imaging lens assembly according to Embodiment 2 of the disclosure will be described below with reference to FIGS. 3A-4D In the embodiment and the following embodiments, parts of descriptions similar to those about Embodiment 1 are omitted for simplicity. FIGS. 3A and 3B show structural schematic diagrams of an optical imaging, lens assembly when an aperture value is 1.46 and 2.05 according to Embodiment 2 of the disclosure respectively.

As shown in FIGS. 3A and 3B, the optical imaging lens assembly sequentially includes from an object side to an image side: an iris diaphragm STO, a first lens E1, a second lens E2, a third lens E3, a fourth lens E4. a fifth lens E5 a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The, third lens E3 has a negative refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power. an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. Light from an abject sequentially penetrates through each of the surfaces S1 to S18 and is finally imaged on the imaging surface S19.

In the embodiment, f is a total effective focal length of the optical imaging lens assembly, and f is 5.75 mm. TTL is a total length of the optical imaging lens assembly, and TTL is 7.24 mm. ImgH is a half of a diagonal length of an effective pixel region on the imaging surface of the optical imaging lens assembly, and ImgH is 5.38 mm. FNOₘᵢₙ is a minimum value of an F-number of the optical imaging lens assembly, and FNOₘᵢₙ is 1.46. FNOₘₐₓ is a maximum value of the F-number of the optical imaging lens assembly, and FNOₘₐₓ is 2.05. A relative aperture of the optical imaging lens assembly is maximum when the F-number is the minimum value. The relative aperture of the optical imaging lens assembly is minimum when the F-number is the maximum value.

Table 3 shows a basic parameter table of the optical imaging lens assembly of Embodiment 2, wherein units of the curvature radius, the thickness/distance and the focal length are all millimeters (mm). Tables 4-1 and 4-2 show high-order coefficients that may be used for each aspheric mirror surface in Embodiment 2. A surface type of each aspheric surface may be defined by formula (1) given in Embodiment 1.

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0800 | | | | |
| S1 | Aspheric | 2.7467 | 0.9605 | 1.55 | 56.1 | 6.06 | 0.0675 |
| S2 | Aspheric | 14.1273 | 0.0511 | | | | 5.3901 |
| S3 | Aspheric | 6.6756 | 0.2500 | 1.67 | 19.2 | −16.15 | −1.2569 |
| S4 | Aspheric | 4.0831 | 0.1692 | | | | 0.0000 |
| S5 | Aspheric | 7.4925 | 0.4467 | 1.55 | 56.1 | −10002.04 | 2.6803 |
| S6 | Aspheric | 7.3247 | 0.4118 | | | | −4.1645 |
| S7 | Aspheric | 9.7914 | 0.2514 | 1.64 | 23.5 | −37.41 | 0.0000 |
| S8 | Aspheric | 6.8936 | 0.0947 | | | | 5.7910 |
| S9 | Aspheric | 10.8228 | 0.6598 | 1.55 | 56.1 | 67.07 | 0.0000 |
| S10 | Aspheric | 15.0335 | 0.3.546 | | | | −5.6728 |
| S11 | Aspheric | 5.6253 | 0.4982 | 1.55 | 56.1 | −436.23 | −2.1927 |
| S12 | Aspheric | 5.3236 | 0.2608 | | | | −24.5423 |
| S13 | Aspheric | 1.9773 | 0.4425 | 1.55 | 56.1 | 4.90 | −0.9136 |
| S14 | Aspheric | 6.9852 | 0.7893 | | | | −0.3492 |
| S15 | Aspheric | 122.1543 | 0.4732 | 1.54 | 55.7 | −4.16 | 0.0000 |
| S16 | Aspheric | 2.1912 | 0.2836 | | | | −1.0993 |
| S17 | Spherical | Infinite | 0.2100 | 1.52 | 64.2 | | |
| S18 | Spherical | Infinite | 0.6313 | | | | |
| S19 | Spherical | Infinite | | | | | |

TABLE 4-1

| Surface | | | | | | | |
|---|---|---|---|---|---|---|---|
| number | A4 | A6 | A8 | A10 | A12 | A14 | A16 |
| S1 | −2.6552E−03 | 3.8138E−03 | −7.7772E−03 | 8.3953E−03 | −5.9550E−03 | 2.6618E−03 | −7.1363E−04 |
| S2 | −1.9042E−02 | −1.2505E−02 | 3.3733E−02 | −3.3354E−02 | 1.9138E−02 | −6.7753E−03 | 1.4197E−03 |
| S3 | −2.5794E−02 | −8.2422E−03 | 3.0309E−02 | −3.2010E−02 | 2.0287E−02 | −8.0884E−03 | 1.9331E−03 |
| S4 | −1.4724E−02 | 1.4226E−03 | −1.2980E−03 | 4.6117E−03 | −7.3847E−03 | 5.4793E−03 | −2.0229E−03 |
| S5 | −1.0738E−03 | 3.6569E−03 | −1.2889E−02 | 2.7513E−02 | −3.0890E−02 | 1.9413E−02 | −6.6544E−03 |
| S6 | −1.3235E−02 | 4.0195E−03 | 1.1937E−02 | −3.2742E−02 | 4.0514E−02 | −2.8093E−02 | 1.1351E−02 |
| S7 | −2.6542E−02 | −1.6510E−02 | 4.1444E−02 | −7.3084E−02 | 7.3170E−02 | −4.7906E−02 | 2.0584E−02 |
| S8 | −6.0345E−02 | 4.6905E−02 | −5.3512E−02 | 4.0874E−02 | −2.4595E−02 | 1.1477E−02 | −3.6446E−03 |
| S9 | −7.7101E−02 | 6.9353E−02 | −7.3698E−02 | 5.5447E−02 | −2.7074E−02 | 8.8953E−03 | −1.8391E−03 |
| S10 | −4.7955E−02 | 4.4405E−03 | 1.0539E−02 | −3.1200E−02 | 2.7908E−02 | −1.4191E−02 | 4.3978E−03 |
| S11 | −2.2396E−02 | −2.3585E−02 | 6.9013E−02 | −7.5178E−02 | 4.1674E−02 | −9.8978E−03 | −2.1604E−03 |
| S12 | −7.2179E−02 | −6.6385E−02 | 1.8208E−01 | −1.8853E−01 | 1.1795E−01 | −4.9466E−02 | 1.4433E−02 |
| S13 | −2.0449E−02 | −1.1859E−01 | 1.4668E−01 | −1.0564E−01 | 5.1260E−02 | −1.7850E−02 | 4.5622E−03 |
| S14 | 7.2217E−02 | −1.2771E−01 | 1.0504E−01 | −5.4620E−02 | 1.9186E−02 | −4.7853E−03 | 8.7433E−04 |
| S15 | −1.5606E−01 | 5.6524E−02 | −1.1708E−03 | −6.0430E−03 | 2.5044E−03 | −5.5845E−04 | 8.1176E−05 |
| S16 | −1.7253E−01 | 9.1518E−02 | −3.6062E−02 | 1.0988E−02 | −2.6114E−03 | 4.7455E−04 | −6.4671E−05 |

TABLE 4-2

| Surface | | | | | | | |
|---|---|---|---|---|---|---|---|
| number | A18 | A20 | A22 | A24 | A26 | A28 | A30 |
| S1 | 9.8368E−05 | −3.9013E−06 | −2.6845E−07 | 0.0000E−00 | 0.0000E−00 | 0.0000E−00 | 0.0000E−00 |
| S2 | −1.5573E−04 | 6.5223E−06 | 0.0000E−00 | 0.0000E−00 | 0.0000E−00 | 0.0000E−00 | 0.0000E−00 |
| S3 | −2.4541E−04 | 1.2257E−05 | 0.0000E−00 | 0.0000E−00 | 0.0000E−00 | 0.0000E−00 | 0.0000E−00 |
| S4 | 3.6880E−04 | −2.7040E−05 | 0.0000E−00 | 0.0000E−00 | 0.0000E−00 | 0.0000E−00 | 0.0000E−00 |
| S5 | 1.1712E−03 | −8.3085E−05 | 0.0000E−00 | 0.0000E−00 | 0.0000E−00 | 0.0000E−00 | 0.0000E−00 |
| S6 | −2.4892E−03 | 2.2929E−04 | 0.0000E−00 | 0.0000E−00 | 0.0000E−00 | 0.0000E−00 | 0.0000E−00 |
| S7 | −5.5252E−03 | 8.2921E−04 | −5.2143E−05 | 0.0000E−00 | 0.0000E−00 | 0.0000E−00 | 0.0000E−00 |
| S8 | 6.6143E−04 | −5.0093E−05 | 0.0000E−00 | 0.0000E−00 | 0.0000E−00 | 0.0000E−00 | 0.0000E−00 |
| S9 | 1.1728E−04 | 4.5013E−05 | −1.0906E−05 | 7.1456E−07 | 0.0000E−00 | 0.0000E−00 | 0.0000E−00 |
| S10 | −8.2367E−04 | 8.5443E−05 | −3.7442E−06 | 0.0000E−00 | 0.0000E−00 | 0.0000E−00 | 0.0000E−00 |
| S11 | 2.6086E−03 | −1.0164E−03 | 2.3361E−04 | −3.4381E−05 | 3.1976E−06 | −1.7186E−07 | 4.0760E−09 |
| S12 | −2.9626E−03 | 4.2559E−04 | −4.1845E−05 | 2.6815E−06 | −1.0087E−07 | 1.6897E−09 | 0.0000E−00 |
| S13 | −8.5814E−04 | 1.1798E−04 | −1.1674E−05 | 8.0778E−07 | −3.7055E−08 | 1.0116E−09 | −1.2437E−11 |
| S14 | −1.1857E−04 | 1.1919E−05 | −8.7558E−07 | 4.5662E−08 | −1.6017E−09 | 3.3926E−11 | −3.2838E−13 |
| S15 | −8.1846E−06 | 5.8532E−07 | −2.9693E−08 | 1.0470E−09 | −2.4428E−11 | 3.3940E−13 | −2.1267E−15 |
| S16 | 6.5246E−06 | −4.8174E−07 | 2.5598E−08 | −9.5076E−10 | 2.3391E−11 | −3.4218E−13 | 2.2517E−15 |

FIGS. 4A and 4C show astigmatism curves of the optical imaging lens assembly according to Embodiment 2 when the aperture value is 1.46 and 2.05 respectively to represent a tangential image surface curvature and a sagittal image surface curvature. FIGS. 4B and 4D show distortion curves of the optical imaging lens assembly according to Embodiment 2 when the aperture value is 1.46 and 2.05 respectively to represent distortion values corresponding to different image heights. According to FIGS. 4A-4D, it can be seen that the optical imaging lens assembly provided in Embodiment 2 may achieve high imaging quality.

Embodiment 3

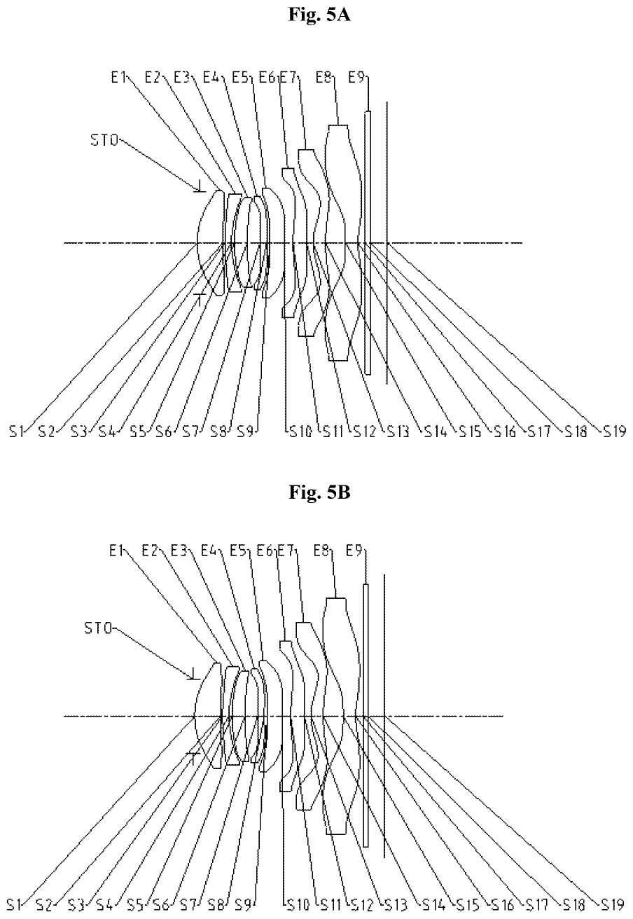

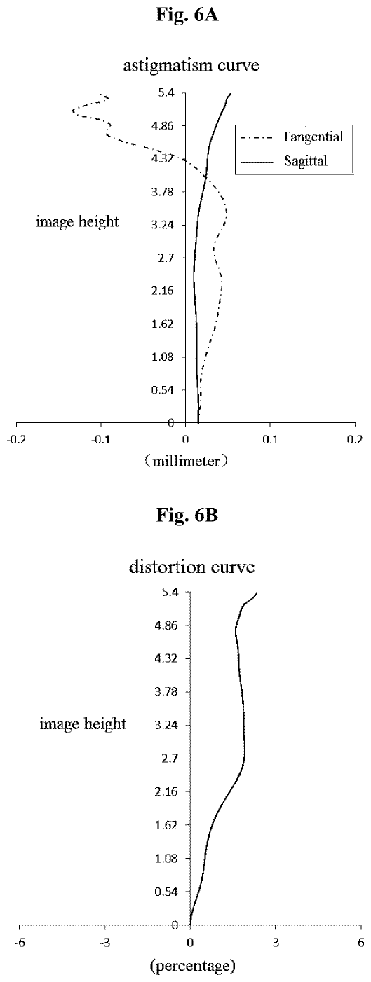

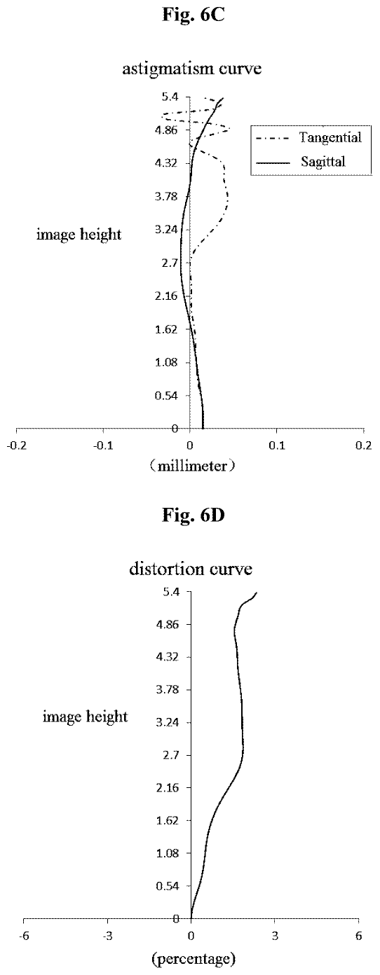

An optical imaging lens assembly according to Embodiment 3 of the disclosure will be described below with reference to FIGS. 5A-6D. FIGS. 5A and 5B show structural schematic diagrams of an optical imaging lens assembly when an aperture value is 1.46 and 2.05 according to Embodiment 3 of the disclosure respectively.

As shown in FIGS. 5A and 5B, the optical imaging lens assembly sequentially includes from an object side to an image side: an iris diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 5.75 mm. TTL is a total length of the optical imaging lens assembly, and TTL is 7.23 mm. ImgH is a half of a diagonal length of an effective pixel region on the imaging surface, of the optical imaging lens assembly, and ImgH is 5.38 mm. FNOₘᵢₙ is a minimum value of an F-number of the optical imaging lens assembly, and FNOₘᵢₙ is 1.46. FNOₘₐₓ is a maximum value of the F-number of the optical imaging lens assembly, and FNOₘₐₓ is 2.05. A relative aperture of the optical imaging lens assembly is maximum when the F-number is the minimum value. The relative aperture of the optical imaging lens assembly is minimum when the F-number is the maximum value.

Table 5 shows a basic parameter table of the optical imaging lens assembly of Embodiment 3, wherein units of the curvature radius, the thickness/distance and the focal length are all millimeters (mm). Tables 6-1 and 6-2 show high-order coefficients that may be used for each aspheric mirror surface in Embodiment 3. A surface type of each aspheric surface may be defined by formula (1) given in Embodiment 1.

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0800 | | | | |
| S1 | Aspheric | 2.7393 | 0.9790 | 1.55 | 56.1 | 6.49 | 0.0748 |
| S2 | Aspheric | 10.5666 | 0.0743 | | | | 4.1837 |
| S3 | Aspheric | 6.3352 | 0.2500 | 1.67 | 19.2 | −11.42 | −1.2201 |
| S4 | Aspheric | 3.4271 | 0.1186 | | | | 0.0000 |
| S5 | Aspheric | 4.9821 | 0.4852 | 1.55 | 56.1 | 20.71 | 1.8328 |
| S6 | Aspheric | 8.6011 | 0.4851 | | | | −2.6261 |
| S7 | Aspheric | 13.1029 | 0.2504 | 1.64 | 23.5 | 98846.46 | 0.0000 |
| S8 | Aspheric | 13.0074 | 0.1157 | | | | 8.7986 |
| S9 | Aspheric | 41.4847 | 0.5725 | 1.55 | 56.1 | −46.31 | 0.0000 |
| S10 | Aspheric | 15.6321 | 0.3165 | | | | −20.9410 |
| S11 | Aspheric | 5.7271 | 0.5190 | 1.55 | 56.1 | −293.37 | −2.2199 |
| S12 | Aspheric | 5.3524 | 0.2486 | | | | −24.6624 |
| S13 | Aspheric | 1.9905 | 0.4701 | 1.55 | 56.1 | 4.87 | −0.9136 |
| S14 | Aspheric | 7.2480 | 0.7608 | | | | −0.4847 |
| S15 | Aspheric | 667.2893 | 0.4682 | 1.54 | 55.7 | −4.18 | 0.0000 |
| S16 | Aspheric | 2.2360 | 0.2809 | | | | −1.0968 |
| S17 | Spherical | Infinite | 0.2100 | 1.52 | 64.2 | | |
| S18 | Spherical | Infinite | 0.6272 | | | | |
| S19 | Spherical | Infinite | | | | | |

TABLE 6-1

| Surface | | | | | | | |
|---|---|---|---|---|---|---|---|
| number | A4 | A6 | A8 | A10 | A12 | A14 | A16 |
| S1 | −1.5455E−03 | −1.5731E−03 | 3.0664E−03 | −4.9367E−03 | 4.5137E−03 | −2.6650E−03 | 1.0266E−03 |
| S2 | −3.8865E−03 | −6.8862E−02 | 1.5762E−01 | −1.8696E−01 | 1.2911E−01 | −5.3541E−02 | 1.3098E−02 |
| S3 | −1.9689E−02 | −1.3589E−02 | 3.2879E−02 | −3.8891E−02 | 2.9418E−02 | −1.3699E−02 | 3.7409E−03 |
| S4 | −1.5229E−02 | 1.4965E−03 | −1.3886E−03 | 5.0177E−03 | −8.1715E−03 | 6.1662E−03 | −2.3152E−03 |
| S5 | −1.3074E−02 | 1.7288E−02 | −4.0454E−02 | 6.0839E−02 | −5.6769E−02 | 3.1704E−02 | −1.0036E−02 |
| S6 | −8.7103E−03 | −2.4694E−03 | 1.7827E−02 | −3.6000E−02 | 4.1046E−02 | −2.7790E−02 | 1.1176E−02 |
| S7 | −2.6602E−02 | −1.6566E−02 | 4.1632E−02 | −7.3500E−02 | 7.3668E−02 | −4.8288E−02 | 2.0771E−02 |
| S8 | −6.0810E−02 | 5.2383E−02 | −6.6174E−02 | 5.6555E−02 | −3.6249E−02 | 1.6786E−02 | −5.0914E−03 |
| S9 | −7.9619E−02 | 7.2778E−02 | −7.8590E−02 | 6.0085E−02 | −2.9814E−02 | 9.9542E−03 | −2.0914E−03 |
| S10 | −5.5385E−02 | 2.0108E−02 | −8.1052E−03 | −7.5261E−03 | 1.1939E−02 | −7.1600E−03 | 2.3989E−03 |
| S11 | −2.5510E−02 | −1.0441E−02 | 4.3203E−02 | −4.2996E−02 | 1.3225E−02 | 8.7197E−03 | −1.1239E−02 |
| S12 | −7.0126E−02 | −6.9585E−02 | 1.8404E−01 | −1.8913E−01 | 1.1789E−01 | −4.9239E−02 | 1.4281E−02 |
| S13 | −1.9322E−02 | −1.2492E−01 | 1.5811E−01 | −1.1683E−01 | 5.8088E−02 | −2.0640E−02 | 5.3576E−03 |
| S14 | 7.0923E−02 | −1.2519E−01 | 1.0401E−01 | −5.4936E−02 | 1.9706E−02 | −5.0408E−03 | 9.4670E−04 |
| S15 | −1.5646E−01 | 5.6741E−02 | −1.1768E−03 | −6.0516E−03 | 2.5237E−03 | −5.6347E−04 | 8.2011E−05 |
| S16 | −1.6894E−01 | 8.9246E−02 | −3.4917E−02 | 1.0550E−02 | −2.4856E−03 | 4.4763E−04 | −6.0394E−05 |

TABLE 6-2

| Surface | | | | | | | |
|---|---|---|---|---|---|---|---|
| number | A18 | A20 | A22 | A24 | A26 | A28 | A30 |
| S1 | −2.5175E−04 | 3.5454E−05 | −2.1594E−06 | 0.0000E+00 | 0.0000E+00 | 0.0000E+00 | 0.0000E+00 |
| S2 | −1.7373E−03 | 9.6128E−05 | 0.0000E+00 | 0.0000E+00 | 0.0000E+00 | 0.0000E+00 | 0.0000E+00 |
| S3 | −5.4373E−04 | 3.2211E−05 | 0.0000E+00 | 0.0000E+00 | 0.0000E+00 | 0.0000E+00 | 0.0000E+00 |
| S4 | 4.2928E−04 | −3.2010E−05 | 0.0000E+00 | 0.0000E+00 | 0.0000E+00 | 0.0000E+00 | 0.0000E+00 |
| S5 | 1.6589E−03 | −1.1089E−04 | 0.0000E+00 | 0.0000E+00 | 0.0000E+00 | 0.0000E+00 | 0.0000E+00 |
| S6 | −2.4469E−03 | 2.2478E−04 | 0.0000E+00 | 0.0000E+00 | 0.0000E+00 | 0.0000E+00 | 0.0000E+00 |
| S7 | −5.5818E−03 | 8.3865E−04 | −5.2797E−05 | 0.0000E+00 | 0.0000E+00 | 0.0000E+00 | 0.0000E+00 |
| S8 | 8.7499E−04 | −6.2908E−05 | 0.0000E+00 | 0.0000E+00 | 0.0000E+00 | 0.0000E+00 | 0.0000E+00 |
| S9 | 1.3553E−04 | 5.2858E−05 | −1.3014E−05 | 8.6651E−07 | 0.0000E+00 | 0.0000E+00 | 0.0000E+00 |
| S10 | −4.7189E−04 | 5.0849E−05 | −2.3011E−06 | 0.0000E+00 | 0.0000E+00 | 0.0000E+00 | 0.0000E+00 |
| S11 | 5.8828E−03 | −1.8791E−03 | 3.9665E−04 | −5.5817E−05 | 5.0536E−06 | −2.6675E−07 | 6.2428E−09 |
| S12 | −2.9065E−03 | 4.1295E−04 | −4.0056E−05 | 2.5259E−06 | −9.3273E−08 | 1.5300E−09 | 0.0000E+00 |
| S13 | −1.0196E−03 | 1.4145E−04 | −1.4104E−05 | 9.8266E−07 | −4.5370E−08 | 1.2467E−09 | −1.5430E−11 |
| S14 | −1.3206E−04 | 1.3654E−05 | −1.0317E−06 | 5.5345E−08 | −1.9969E−09 | 4.3485E−11 | −4.3221E−13 |
| S15 | −8.2793E−06 | 5.9285E−07 | −3.0114E−08 | 1.0631E−09 | −2.4838E−11 | 3.4552E−13 | −2.1678E−15 |
| S16 | 6.0256E−06 | −4.3954E−07 | 2.3060E−08 | −8.4527E−10 | 2.0522E−11 | −2.9627E−13 | 1.9245E−15 |

FIGS. 6A and 6C show astigmatism curves of the optical imaging lens assembly according to Embodiment 3 when the aperture value is 1.46 and 2.05 respectively to represent a tangential image surface curvature and a sagittal image surface curvature. FIGS. 6B and 6D show distortion curves of the optical imaging lens assembly according to Embodiment 3 when the aperture value is 1.46 and 2.05 respectively to represent distortion values corresponding to different image heights. According to FIGS. 6A-6D, it can be seen that the optical imaging lens assembly provided in Embodiment 3 may achieve high imaging quality.

Embodiment 4

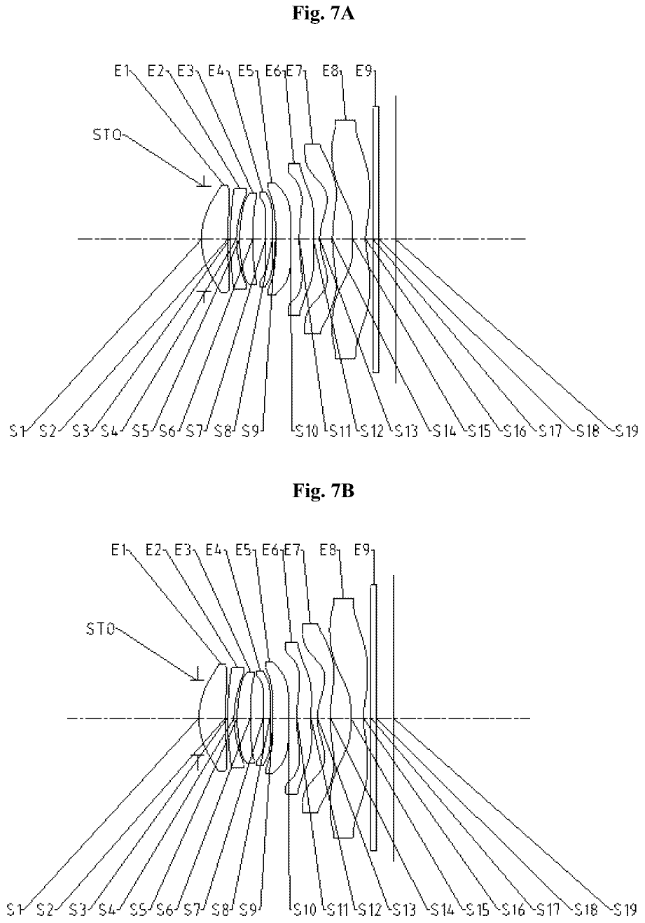

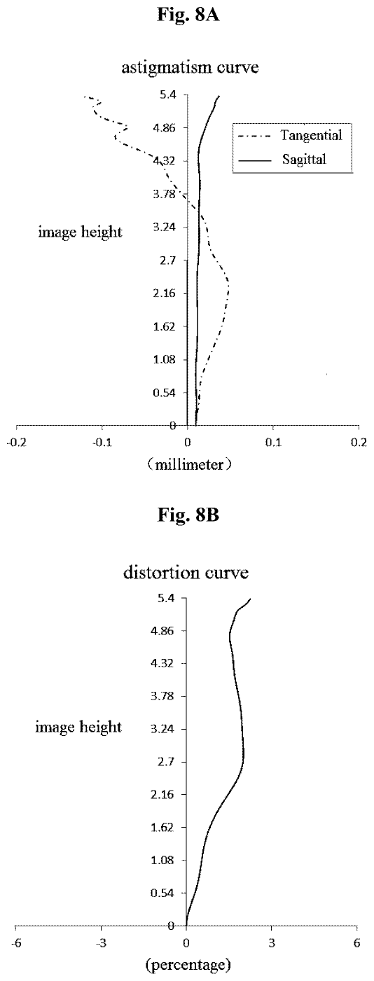

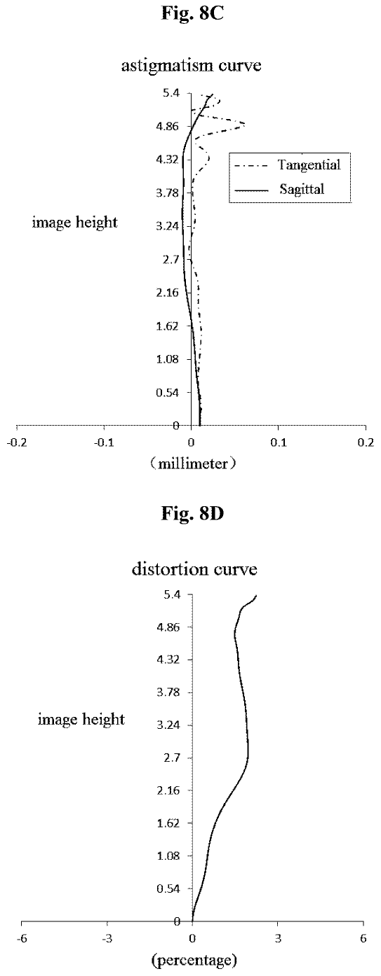

An optical imaging lens assembly according to Embodiment 4 of the disclosure will be described below with reference to FIGS. 7A-8D. FIGS. 7A and 7B show structural schematic diagrams of an optical imaging lens assembly when an aperture value is 1.46 and 2.05 according to Embodiment 4 of the disclosure respectively.

As shown in FIGS. 7A and 7B, the optical imaging lens assembly sequentially includes from an object side to an image side: an iris diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19,

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 5.75 mm. TTL is a total length of the optical imaging lens assembly, and TTL is 7.24 mm. ImgH is a half of a diagonal length of an effective pixel region on the imaging surface, of the optical imaging lens assembly, and ImgH is 5.38 mm. FNOₘᵢₙ is a minimum value of an F-number of the optical imaging lens assembly, and FNOₘᵢₙ is 1.46. FNOₘₐₓ is a maximum value of the F-number of the optical imaging lens assembly, and FNOₘₐₓ is 2.05. A relative aperture of the optical imaging lens assembly is maximum when the F-number is the minimum value. The relative aperture of the optical imaging lens assembly is minimum when the F-number is the maximum value.

Table 7 shows a basic parameter table of the optical imaging lens assembly of Embodiment 4, wherein units of the curvature radius, the thickness/distance and the focal length are all millimeters (mm). Tables 8-1 and 8-2 show high-order coefficients that may be used for each aspheric mirror surface in Embodiment 4. A surface type of each aspheric surface may be defined by formula (1) given in Embodiment 1.

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0800 | | | | |
| S1 | Aspheric | 2.7383 | 0.9806 | 1.55 | 56.1 | 6.50 | 0.0751 |
| S2 | Aspheric | 10.4652 | 0.0746 | | | | 4.1500 |
| S3 | Aspheric | 6.2948 | 0.2500 | 1.67 | 19.2 | −11.50 | −1.2122 |
| S4 | Aspheric | 3.4260 | 0.1185 | | | | 0.0000 |
| S5 | Aspheric | 4.9846 | 0.4854 | 1.55 | 56.1 | 20.38 | 1.8360 |
| S6 | Aspheric | 8.7186 | 0.4852 | | | | −2.6063 |
| S7 | Aspheric | 13.3711 | 0.2500 | 1.64 | 23.5 | −212.86 | 0.0000 |
| S8 | Aspheric | 12.0945 | 0.1156 | | | | 8.7139 |
| S9 | Aspheric | 33.3759 | 0.5713 | 1.55 | 56.1 | −54.28 | 0.0000 |
| S10 | Aspheric | 15.6016 | 0.3165 | | | | −21.2508 |
| S11 | Aspheric | 5.7216 | 0.5191 | 1.55 | 56.1 | −294.96 | −2.2172 |
| S12 | Aspheric | 5.3483 | 0.2484 | | | | −24.6775 |
| S13 | Aspheric | 1.9899 | 0.4721 | 1.55 | 56.1 | 4.87 | −0.9136 |
| S14 | Aspheric | 7.2456 | 0.7627 | | | | −0.4841 |
| S15 | Aspheric | 653.4146 | 0.4720 | 1.54 | 55.7 | −4.18 | 0.0000 |
| S16 | Aspheric | 2.2382 | 0.2809 | | | | −1.0968 |
| S17 | Spherical | Infinite | 0.2100 | 1.52 | 64.2 | | |
| S18 | Spherical | Infinite | 0.6273 | | | | |
| S19 | Spherical | Infinite | | | | | |

TABLE 8-1

| Surface | | | | | | | |
|---|---|---|---|---|---|---|---|
| number | A4 | A6 | A8 | A10 | A12 | A14 | A16 |
| S1 | −1.5865E−03 | −1.4637E−03 | 2.8981E−03 | −4.7719E−03 | 4.4112E−03 | −2.6235E−03 | 1.0153E−03 |
| S2 | −3.6529E−03 | −6.9396E−02 | 1.5806E−01 | −1.8702E−01 | 1.2898E−01 | −5.3447E−02 | 1.3070E−02 |
| S3 | −1.9699E−02 | −1.4035E−02 | 3.4256E−02 | −4.0737E−02 | 3.0793E−02 | −1.4308E−02 | 3.9003E−03 |
| S4 | −1.5232E−02 | 1.4969E−03 | −1.3891E−03 | 5.0200E−03 | −8.1761E−03 | 6.1703E−03 | −2.3170E−03 |
| S5 | −1.2967E−02 | 1.6673E−02 | −3.9181E−02 | 5.9307E−02 | −5.5578E−02 | 3.1101E−02 | −9.8460E−03 |
| S6 | −8.7776E−03 | −2.1559E−03 | 1.6804E−02 | −3.3890E−02 | 3.8574E−02 | −2.6107E−02 | 1.0510E−02 |
| S7 | −2.6602E−02 | −1.6566E−02 | 4.1631E−02 | −7.3496E−02 | 7.3665E−02 | −4.8285E−02 | 2.0770E−02 |
| S8 | −6.0744E−02 | 5.2202E−02 | −6.5889E−02 | 5.6195E−02 | −3.5940E−02 | 1.6625E−02 | −5.0432E−03 |
| S9 | −7.9653E−02 | 7.2825E−02 | −7.8658E−02 | 6.0150E−02 | −2.9853E−02 | 9.9692E−03 | −2.0950E−03 |
| S10 | −5.5400E−02 | 2.0311E−02 | −8.6630E−03 | −6.8123E−03 | 1.1406E−02 | −6.9123E−03 | 2.3267E−03 |
| S11 | −2.5583E−02 | −9.9934E−03 | 4.1860E−02 | −4.0728E−02 | 1.0842E−02 | 1.0390E−02 | −1.2051E−02 |
| S12 | −7.0128E−02 | −6.9563E−02 | 1.8398E−01 | −1.8905E−01 | 1.1782E−01 | −4.9206E−02 | 1.4269E−02 |
| S13 | −1.9321E−02 | −1.2494E−01 | 1.5815E−01 | −1.1687E−01 | 5.8114E−02 | −2.0652E−02 | 5.3613E−03 |
| S14 | 7.0954E−02 | −1.2530E−01 | 1.0417E−01 | −5.5065E−02 | 1.9772E−02 | −5.0638E−03 | 9.5227E−04 |
| S15 | −1.5645E−01 | 5.6736E−02 | −1.1767E−03 | −6.0507E−03 | 2.5233E−03 | −5.6336E−04 | 8.1993E−05 |
| S16 | −1.6894E−01 | 8.9298E−02 | −3.4974E−02 | 1.0579E−02 | −2.4946E−03 | 4.4942E−04 | −6.0641E−05 |

TABLE 8-2

| Surface | | | | | | | |
|---|---|---|---|---|---|---|---|
| number | A18 | A20 | A22 | A24 | A26 | A28 | A30 |
| S1 | −2.4969E−04 | 3.5220E−05 | −2.1467E−06 | 0.0000E+00 | 0.0000E+00 | 0.0000E+00 | 0.0000E+00 |
| S2 | −1.7332E−03 | 9.5898E−05 | 0.0000E+00 | 0.0000E+00 | 0.0000E+00 | 0.0000E+00 | 0.0000E+00 |
| S3 | −5.6654E−04 | 3.3586E−05 | 0.0000E+00 | 0.0000E+00 | 0.0000E+00 | 0.0000E+00 | 0.0000E+00 |
| S4 | 4.2964E−04 | −3.2040E−05 | 0.0000E+00 | 0.0000E+00 | 0.0000E+00 | 0.0000E+00 | 0.0000E+00 |
| S5 | 1.6249E−03 | −1.0828E−04 | 0.0000E+00 | 0.0000E+00 | 0.0000E+00 | 0.0000E+00 | 0.0000E+00 |
| S6 | −2.3046E−03 | 2.1203E−04 | 0.0000E+00 | 0.0000E+00 | 0.0000E+00 | 0.0000E+00 | 0.0000E+00 |
| S7 | −5.5814E−03 | 8.3858E−04 | −5.2792E−05 | 0.0000E+00 | 0.0000E+00 | 0.0000E+00 | 0.0000E+00 |
| S8 | 8.6733E−04 | −6.2413E−05 | 0.0000E+00 | 0.0000E+00 | 0.0000E+00 | 0.0000E+00 | 0.0000E+00 |
| S9 | 1.3579E−04 | 5.2972E−05 | −1.3045E−05 | 8.6875E−07 | 0.0000E+00 | 0.0000E+00 | 0.0000E+00 |
| S10 | −4.5914E−04 | 4.9601E−05 | −2.24S4E−06 | 0.0000E+00 | 0.0000E+00 | 0.0000E+00 | 0.0000E+00 |
| S11 | 6.1632E−03 | −1.9482E−03 | 4.0875E−04 | −5.7284E−05 | 5.1708E−06 | −2.7229E−07 | 6.3602E−09 |
| S12 | −2.9038E−03 | 4.1251E−04 | −4.0008E−05 | 2.5226E−06 | −9.3141E−08 | 1.5276E−09 | 0.0000E+00 |
| S13 | −1.0204E−03 | 1.4159E−04 | −1.4119E−05 | 9.8383E−07 | −4.5431E−08 | 1.2485E−09 | −1.5455E−11 |
| S14 | −1.3302E−04 | 1.3772E−05 | −1.0421E−06 | 5.5976E−08 | −2.0222E−09 | 4.4085E−11 | −4.3859E−13 |
| S15 | −8.2773E−06 | 5.9269E−07 | −3.0105E−08 | 1.0628E−09 | −2.4829E−11 | 3.4539E−13 | −2.1670E−15 |
| S16 | 6.0494E−06 | −4.4116E−07 | 2.3137E−08 | −8.4777E−10 | 2.0574E−11 | −2.9689E−13 | 1.9277E−15 |

FIGS. 8A and 8C show astigmatism curves of the optical imaging lens assembly according to Embodiment 4 when the aperture value is 1.46 and 2.05 respectively to represent a tangential image surface curvature and a sagittal image surface curvature. FIGS. 8B and 8D show distortion curves of the optical imaging lens assembly according to Embodiment 4 when the aperture value is 1.46 and 2.05 respectively to represent distortion values corresponding to different image heights. According to FIGS. 8A-8D, it can be seen that the optical imaging lens assembly provided in Embodiment 4 may achieve high imaging quality.

Embodiment 5

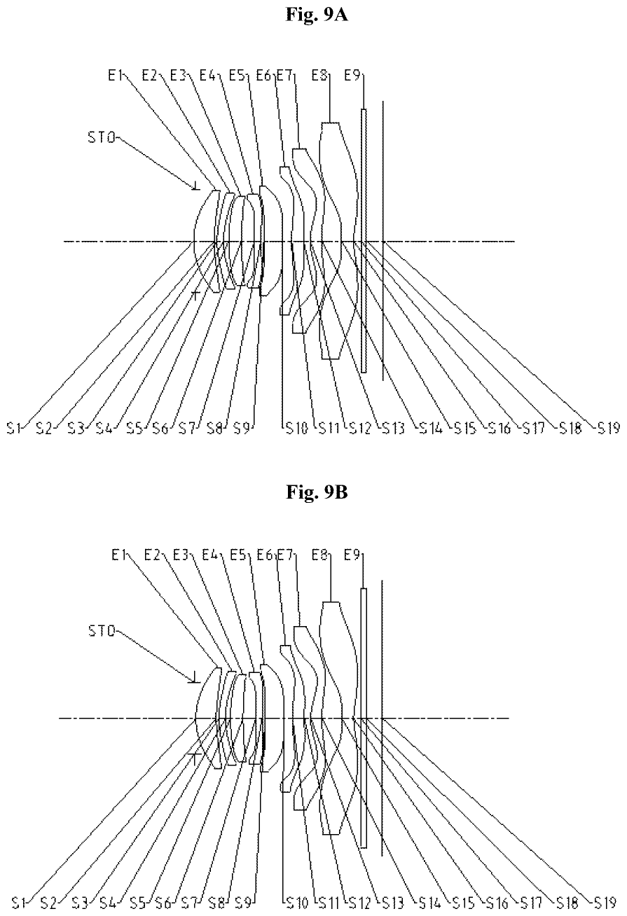

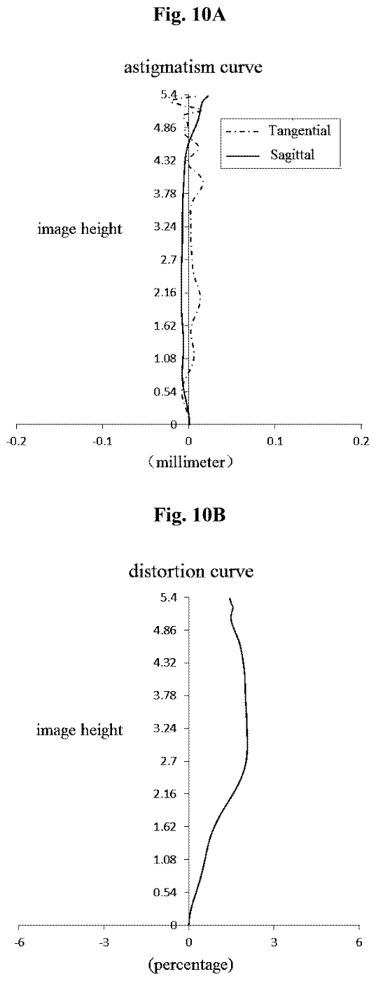

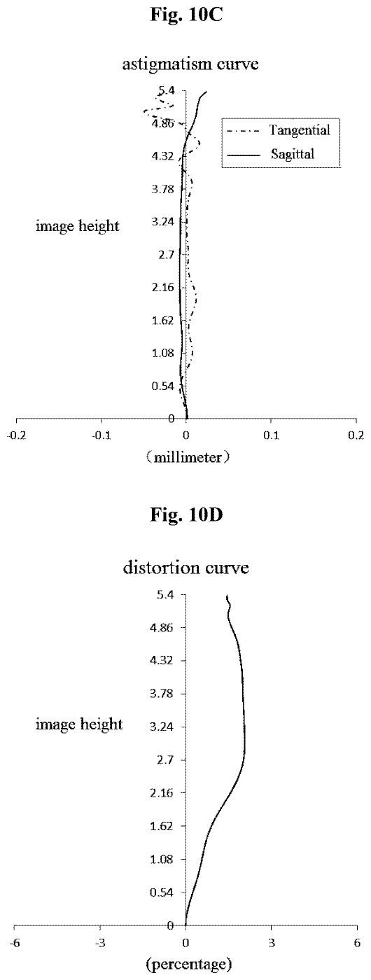

An optical imaging lens assembly according to Embodiment 5 of the disclosure will be described below with reference to FIGS. 9A-10D. FIGS. 9A and 9B show structural schematic diagrams of an optical imaging lens assembly when an aperture value is 1.47 and 2.05 according to Embodiment 5 of the disclosure respectively.

As shown in FIGS. 9A and 9B, the optical imaging lens assembly sequentially includes from an object side to an image side: an iris diaphragm STO, a first lens E1 , a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 5.75 m. TTL is a total length of the optical imaging lens assembly, and TTL is 7.24 mm. ImgH is a half of a diagonal length of an effective pixel region on the imaging surface, of the optical imaging lens assembly, and ImgH is 5.38 mm. FNOₘᵢₙ is a minimum value of an F-number of the optical imaging lens assembly, and FNOₘᵢₙ is 1.47. FNOₘₐₓ is a maximum value of the F-number of the optical imaging lens assembly, and FNOₘₐₓ is 2.05. A relative aperture of the optical imaging lens assembly is maximum when the F-number is the minimum value. The relative aperture of the optical imaging lens assembly is minimum when the F-number is the maximum value.

Table 9 shows a basic parameter table of the optical imaging lens assembly of Embodiment 5, wherein units of the curvature radius, the thickness/distance and the focal length are all millimeters (mm). Tables 10-1 and 10-2 show high-order coefficients that may be used for each aspheric mirror surface in Embodiment 5. A surface type of each aspheric surface may be defined by formula (1) given in Embodiment 1.

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0800 | | | | |
| S1 | Aspheric | 2.7128 | 0.7857 | 1.55 | 56.1 | 9.77 | 0.1297 |
| S2 | Aspheric | 4.9582 | 0.1131 | | | | 1.3338 |
| S3 | Aspheric | 3.4080 | 0.2500 | 1.67 | 19.2 | −292.87 | −1.4016 |
| S4 | Aspheric | 3.2512 | 0.1910 | | | | 0.0000 |
| S5 | Aspheric | 5.8097 | 0.4887 | 1.55 | 56.1 | 25.23 | 3.1612 |
| S6 | Aspheric | 9.7499 | 0.4944 | | | | −14.0893 |
| S7 | Aspheric | 17.9036 | 0.2500 | 1.64 | 23.5 | −18.73 | 0.0000 |
| S8 | Aspheric | 7.1720 | 0.1098 | | | | 7.1991 |
| S9 | Aspheric | 12.2637 | 0.7163 | 1.55 | 56.1 | 55.21 | 0.0000 |
| S10 | Aspheric | 20.2503 | 0.3498 | | | | −49.5982 |
| S11 | Aspheric | 6.3162 | 0.4575 | 1.55 | 56.1 | 651.90 | −2.1657 |
| S12 | Aspheric | 6.2658 | 0.2513 | | | | −27.9866 |
| S13 | Aspheric | 2.0797 | 0.4407 | 1.55 | 56.1 | 4.93 | −0.9188 |
| S14 | Aspheric | 8.4806 | 0.7648 | | | | 0.1216 |
| S15 | Aspheric | −93.1154 | 0.4557 | 1.54 | 55.7 | −4.06 | 0.0000 |
| S16 | Aspheric | 2.2350 | 0.2818 | | | | −1.1176 |
| S17 | Spherical | Infinite | 0.2100 | 1.52 | 64.2 | | |
| S18 | Spherical | Infinite | 0.6297 | | | | |
| S19 | Spherical | Infinite | | | | | |

TABLE 10-1

| Surface | | | | | | | |
|---|---|---|---|---|---|---|---|
| number | A4 | A6 | A8 | A10 | A12 | A14 | A16 |
| S1 | −2.0315E−03 | −1.1709E−03 | 3.2120E−03 | −5.3954E−03 | 4.9608E−03 | −2.8906E−03 | 1.0839E−03 |
| S2 | −2.7546E−02 | 1.1004E−02 | −5.5820E−03 | 1.0988E−03 | 3.2324E−04 | −1.4523E−04 | −2.4630E−05 |
| S3 | −2.9577E−02 | 9.2305E−03 | −1.2318E−03 | −3.0427E−03 | 2.4712E−03 | −5.0908E−04 | −1.1784E−04 |
| S4 | −1.5024E−02 | 1.4664E−03 | −1.3515E−03 | 4.8507E−03 | −7.8463E−03 | 5.8809E−03 | −2.1932E−03 |
| S5 | −9.4166E−03 | 1.6820E−02 | −3.9634E−02 | 5.3956E−02 | −4.4535E−02 | 2.2250E−02 | −6.3687E−03 |
| S6 | −2.4200E−03 | −1.1286E−02 | 3.3092E−02 | −5.9247E−02 | 6.2221E−02 | −3.9468E−02 | 1.4986E−02 |
| S7 | −2.6168E−02 | −1.6162E−02 | 4.0283E−02 | −7.0534E−02 | 7.0116E−02 | −4.5582E−02 | 1.9447E−02 |
| S8 | −6.0195E−02 | 4.3023E−02 | −3.7654E−02 | 1.8785E−02 | −5.5720E−03 | 1.2730E−03 | −3.5314E−04 |
| S9 | −7.5359E−02 | 6.7015E−02 | −7.0405E−02 | 5.2367E−02 | −2.5280E−02 | 8.2113E−03 | −1.6784E−03 |
| S10 | −5.1422E−02 | 1.3412E−02 | 7.1751E−03 | −2.9877E−02 | 3.0098E−02 | −1.6184E−02 | 5.2323E−03 |
| S11 | −1.8313E−02 | −5.6807E−02 | 1.5989E−01 | −2.0446E−01 | 1.5897E−01 | −8.3582E−02 | 3.1083E−02 |
| S12 | −7.4738E−02 | −7.6868E−02 | 2.0881E−01 | −2.1875E−01 | 1.3865E−01 | −5.8846E−02 | 1.7342E−02 |
| S13 | −2.2375E−02 | −1.0080E−01 | 1.2182E−01 | −8.9248E−02 | 4.4908E−02 | −1.6238E−02 | 4.2712E−03 |
| S14 | 6.2940E−02 | −8.9407E−02 | 5.1489E−02 | −1.4206E−02 | −2.9343E−05 | 1.4325E−03 | −6.5262E−04 |
| S15 | −1.5858E−01 | 5.7898E−02 | −1.2089E−03 | −6.2586E−03 | 2.6277E−03 | −5.9064E−04 | 8.6546E−05 |
| S16 | −1.6521E−01 | 8.1678E−02 | −2.8050E−02 | 7.0718E−03 | −1.3830E−03 | 2.1362E−04 | −2.5806E−05 |

TABLE 10-2

| Surface | | | | | | | |
|---|---|---|---|---|---|---|---|
| number | A18 | A20 | A22 | A24 | A26 | A28 | A30 |
| S1 | −2.5637E−04 | 3.4977E−05 | −2.0978E−06 | 0.0000E−00 | 0.0000E−00 | 0.0000E−00 | 0.0000E−00 |
| S2 | 1.9900E−05 | −2.6334E−06 | 0.0000E−00 | 0.0000E−00 | 0.0000E−00 | 0.0000E−00 | 0.0000E−00 |
| S3 | 6.3702E−05 | −7.3236E−06 | 0.0000E−00 | 0.0000E−00 | 0.0000E−00 | 0.0000E−00 | 0.0000E−00 |
| S4 | 4.0392E−04 | −2.9915E−05 | 0.0000E−00 | 0.0000E−00 | 0.0000E−00 | 0.0000E−00 | 0.0000E−00 |
| S5 | 9.5293E−04 | −5.6938E−05 | 0.0000E−00 | 0.0000E−00 | 0.0000E−00 | 0.0000E−00 | 0.0000E−00 |
| S6 | −3.1253E−03 | 2.7589E−04 | 0.0000E−00 | 0.0000E−00 | 0.0000E−00 | 0.0000E−00 | 0.0000E−00 |
| S7 | −5.1829E−03 | 7.7234E−04 | −4.8223E−05 | 0.0000E−00 | 0.0000E−00 | 0.0000E−00 | 0.0000E−00 |
| S8 | 7.8993E−05 | −7.0641E−06 | 0.0000E−00 | 0.0000E−00 | 0.0000E−00 | 0.0000E−00 | 0.0000E−00 |
| S9 | 1.0582E−04 | 4.0151E−05 | −9.6174E−06 | 6.2298E−07 | 0.0000E−00 | 0.0000E−00 | 0.0000E−00 |
| S10 | −1.0204E−03 | 1.1065E−04 | −5.1136E−06 | 0.0000E−00 | 0.0000E−00 | 0.0000E−00 | 0.0000E−00 |
| S11 | −8.3246E−03 | 1.6076E−03 | −2.2059E−04 | 2.0769E−05 | −1.2541E−06 | 4.2463E−08 | −5.7623E−10 |
| S12 | −3.5872E−03 | 5.1806E−04 | −5.1084E−05 | 3.2750E−06 | −1.2296E−07 | 2.0509E−09 | 0.0000E−00 |
| S13 | −8.1700E−04 | 1.1302E−04 | −1.1164E−05 | 7.6741E−07 | −3.4902E−08 | 9.4557E−10 | −1.1579E−11 |
| S14 | 1.1829E−04 | −1.6642E−05 | 1.6020E−06 | −1.0494E−07 | 4.4824E−09 | −1.1271E−10 | 1.2663E−12 |
| S15 | −8.7962E−06 | 6.3411E−07 | −3.2427E−08 | 1.1525E−09 | −2.7108E−11 | 3.7066E−13 | −2.3981E−15 |
| S16 | 2.3873E−06 | −1.6527E−07 | 8.3413E−09 | −2.9630E−10 | 6.9944E−12 | −9.8287E−14 | 6.2131E−16 |

FIGS. 10A and 10C show astigmatism curves of the optical imaging lens assembly according to Embodiment 5 when the aperture value is 1.47 and 2.05 respectively to represent a tangential image surface curvature and a sagittal image surface curvature. FIGS. 10B and 10D show distortion curves of the optical imaging lens assembly according to Embodiment 5 when the aperture value is 1.47 and 2.05 respectively to represent distortion values corresponding to different image heights. According to FIGS. 10A-10D, it can be seen that the optical imaging lens assembly provided in Embodiment 5 may achieve high imaging quality.

Embodiment 6

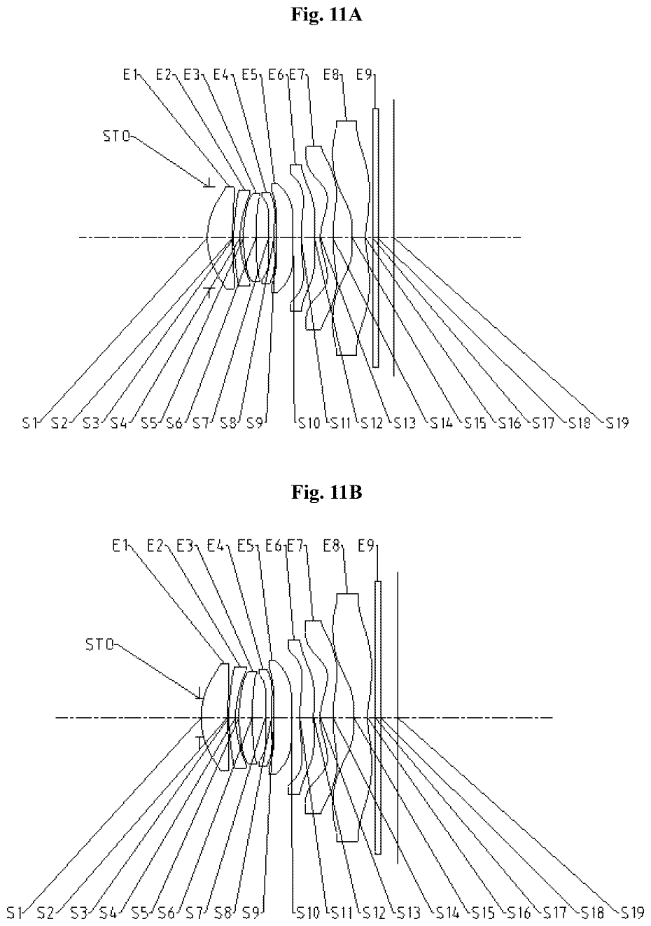

An optical imaging lens assembly according to Embodiment 6 of the disclosure will be described below with reference to FIGS. 11A-120. FIGS. 11A and 11B show structural schematic diagrams of an optical imaging lens assembly when an aperture value is 1.46 and 4.00 according to Embodiment 6 of the disclosure respectively.

As shown in FIGS. 11A and 11B, the optical imaging lens assembly sequentially includes from an object side to an image side: an iris diaphragm STO, a first lens E1, a second lens E2, a third lens E3, a fourth lens E4, a fifth lens E5, a sixth lens E6, a seventh lens E7 an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 5.75 mm. TTL is a total length of the optical imaging lens assembly, and TTL is 7.24 mm. ImgH is a half of a diagonal length of an effective pixel region on the imaging surface, of the optical imaging lens assembly, and ImgH is 5.38 mm. FNOₘᵢₙ is a minimum value of an F-number of the optical imaging lens assembly, and FNOₘᵢₙ is 1.46. FNOₘₐₓ is a maximum value of the F-number of the optical imaging lens assembly, and FNOₘₐₓ is 4.00. A relative aperture of the optical imaging lens assembly is maximum when the F-number is the minimum value. The relative aperture of the optical imaging lens assembly is minimum when the F-number is the maximum value.

Table 11 shows a basic parameter table of the optical imaging lens assembly of Embodiment 6, wherein units of the curvature radius, the thickness/distance and the focal length are all millimeters (mm). Tables 12-1 and 12-2 show high-order coefficients that may be used for each aspheric mirror surface in Embodiment 6. A surface type of each aspheric surface may be defined by formula (1) given in Embodiment 1.

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0800 | | | | |
| S1 | Aspheric | 2.7317 | 0.9697 | 1.55 | 56.1 | 6.90 | 0.0838 |
| S2 | Aspheric | 8.6919 | 0.0500 | | | | 3.2703 |
| S3 | Aspheric | 5.4188 | 0.2500 | 1.67 | 19.2 | −13.70 | −0.9825 |
| S4 | Aspheric | 3.3573 | 0.1253 | | | | 0.0000 |
| S5 | Aspheric | 5.0172 | 0.4854 | 1.55 | 56.1 | 19.16 | 1.8997 |
| S6 | Aspheric | 9.3137 | 0.4879 | | | | 0.4927 |
| S7 | Aspheric | 14.6778 | 0.2200 | 1.64 | 23.5 | −24.86 | 0.0000 |
| S8 | Aspheric | 7.6159 | 0.0910 | | | | 5.0492 |
| S9 | Aspheric | 12.6741 | 0.6427 | 1.55 | 56.1 | 110.14 | 0.0000 |
| S10 | Aspheric | 15.7714 | 0.3106 | | | | −29.0116 |
| S11 | Aspheric | 5.7615 | 0.5108 | 1.55 | 56.1 | −242.00 | −2.2949 |
| S12 | Aspheric | 5.3479 | 0.2395 | | | | −26.0582 |
| S13 | Aspheric | 1.9840 | 0.4815 | 1.55 | 56.1 | 4.85 | −0.9148 |
| S14 | Aspheric | 7.2522 | 0.7558 | | | | −0.3872 |
| S15 | Aspheric | 292.4966 | 0.5000 | 1.54 | 55.7 | −4.20 | 0.0000 |
| S16 | Aspheric | 2.2384 | 0.2816 | | | | −1.0869 |
| S17 | Spherical | Infinite | 0.2100 | 1.52 | 64.2 | | |
| S18 | Spherical | Infinite | 0.6277 | | | | |
| S19 | Spherical | Infinite | | | | | |

TABLE 12-1

| Surface | | | | | | | |
|---|---|---|---|---|---|---|---|
| number | A4 | A6 | A8 | A10 | A12 | A14 | A16 |
| S1 | −1.6427E−03 | −1.9142E−04 | −4.7824E−04 | 9.0717E−05 | 1.6177E−04 | −2.6299E−04 | 1.7409E−04 |
| S2 | −1.2980E−02 | −1.1004E−02 | 2.1850E−02 | −2.4358E−02 | 1.6992E−02 | −7.2641E−03 | 1.8127E−03 |
| S3 | −1.8872E−02 | −1.2653E−02 | 3.1529E−02 | −3.8106E−02 | 2.8751E−02 | −1.3187E−02 | 3.5276E−03 |
| S4 | −1.5440E−02 | 1.5277E−03 | −1.4274E−03 | 5.1935E−03 | −8.5163E−03 | 6.4708E−03 | −2.4464E−03 |
| S5 | −1.1943E−02 | 1.5424E−02 | −3.9441E−02 | 6.0479E−02 | −5.6455E−02 | 3.1460E−02 | −9.9347E−03 |
| S6 | −6.0941E−03 | −2.2799E−03 | 1.2934E−02 | −2.7226E−02 | 3.1963E−02 | −2.2125E−02 | 9.1046E−03 |
| S7 | −2.6593E−02 | −1.6557E−02 | 4.1601E−02 | −7.3431E−02 | 7.3586E−02 | −4.8225E−02 | 2.0740E−02 |
| S8 | −6.5854E−02 | 5.4581E−02 | −6.3739E−02 | 5.1671E−02 | −3.2082E−02 | 1.4870E−02 | −4.6206E−03 |
| S9 | −8.1008E−02 | 7.4691E−02 | −8.1357E−02 | 6.2741E−02 | −3.1403E−02 | 1.0575E−02 | −2.2412E−03 |
| S10 | −4.9714E−02 | 4.7875E−03 | 1.7816E−02 | −3.6902E−02 | 3.3284E−02 | −1.7251E−02 | 5.4999E−03 |
| S11 | −2.1861E−02 | −2.7705E−02 | 7.8683E−02 | −8.8601E−02 | 5.3978E−02 | −1.7556E−02 | 1.1123E−03 |
| S12 | −6.8929E−02 | −7.7912E−02 | 1.9688E−01 | −2.0064E−01 | 1.2523E−01 | −5.2715E−02 | 1.5481E−02 |
| S13 | −1.8998E−02 | −1.2769E−01 | 1.6418E−01 | −1.2398E−01 | 6.3236E−02 | −2.3069E−02 | 6.1400E−03 |
| S14 | 6.7332E−02 | −1.1530E−01 | 9.1665E−02 | −4.5911E−02 | 1.5414E−02 | −3.6369E−03 | 6.2087E−04 |
| S15 | −1.5773E−01 | 5.7431E−02 | −1.1959E−03 | −6.1747E−03 | 2.5855E−03 | −5.7959E−04 | 8.4697E−05 |
| S16 | −1.6743E−01 | 8.6085E−02 | −3.1962E−02 | 9.0157E−03 | −1.9824E−03 | 3.3636E−04 | −4.3211E−05 |

TABLE 12-2

| Surface | | | | | | | |
|---|---|---|---|---|---|---|---|
| number | A18 | A20 | A22 | A24 | A26 | A28 | A30 |
| S1 | −6.2974E−05 | 1.1722E−05 | −8.6808E−07 | 0.0000E−00 | 0.0000E−00 | 0.0000E−00 | 0.0000E−00 |
| S2 | −2.3821E−04 | 1.2514E−05 | 0.0000E−00 | 0.0000E−00 | 0.0000E−00 | 0.0000E−00 | 0.0000E−00 |
| S3 | −5.0013E−04 | 2.8721E−05 | 0.0000E−00 | 0.0000E−00 | 0.0000E−00 | 0.0000E−00 | 0.0000E−00 |
| S4 | 4.5673E−04 | −3.4292E−05 | 0.0000E−00 | 0.0000E−00 | 0.0000E−00 | 0.0000E−00 | 0.0000E−00 |
| S5 | 1.6374E−03 | −1.0903E−04 | 0.0000E−00 | 0.0000E−00 | 0.0000E−00 | 0.0000E−00 | 0.0000E−00 |
| S6 | −2.0409E−03 | 1.9200E−04 | 0.0000E−00 | 0.0000E−00 | 0.0000E−00 | 0.0000E−00 | 0.0000E−00 |
| S7 | −5.5725E−03 | 8.3710E−04 | −5.2689E−05 | 0.0000E−00 | 0.0000E−00 | 0.0000E−00 | 0.0000E−00 |
| S8 | 8.2014E−04 | −6.0981E−05 | 0.0000E−00 | 0.0000E−00 | 0.0000E−00 | 0.0000E−00 | 0.0000E−00 |
| S9 | 1.4650E−04 | 5.7633E−05 | −1.4313E−05 | 9.6128E−07 | 0.0000E−00 | 0.0000E−00 | 0.0000E−00 |
| S10 | −1.0680E−03 | 1.1575E−04 | −5.3490E−06 | 0.0000E−00 | 0.0000E−00 | 0.0000E−00 | 0.0000E−00 |
| S11 | 1.6447E−03 | −8.2285E−04 | 2.0809E−04 | −3.2379E−05 | 3.1315E−06 | −1.7346E−07 | 4.2166E−09 |
| S12 | −3.2013E−03 | 4.6329E−04 | −4.5863E−05 | 2.9566E−06 | −1.1178E−07 | 1.8800E−09 | 0.0000E−00 |
| S13 | −1.1958E−03 | 1.6950E−04 | −1.7241E−05 | 1.2241E−06 | −5.7543E−08 | 1.6088E−09 | −2.0247E−11 |
| S14 | −7.7594E−05 | 7.0782E−06 | −4.6376E−07 | 2.1142E−08 | −6.3339E−10 | 1.1157E−11 | −8.7164E−14 |
| S15 | −8.5851E−06 | 6.1722E−07 | −3.1479E−08 | 1.1158E−09 | −2.6174E−11 | 3.6558E−13 | −2.3029E−15 |
| S16 | 4.1375E−06 | −2.9115E−07 | 1.4781E−08 | −5.2525E−10 | 1.2375E−11 | −1.7345E−13 | 1.0940E−15 |

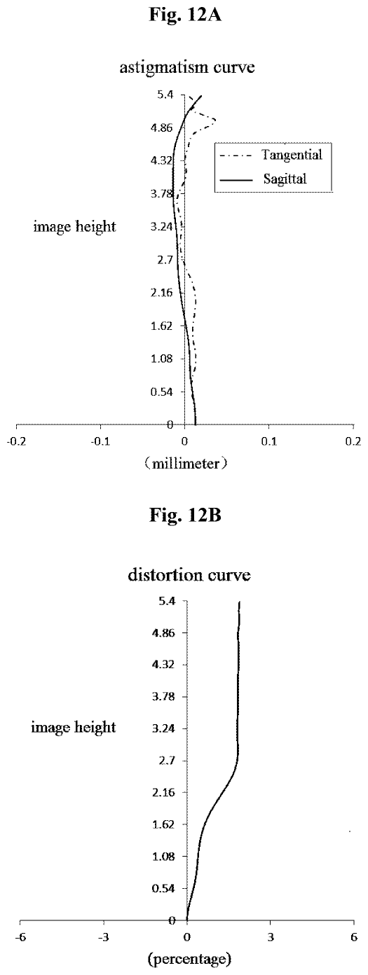

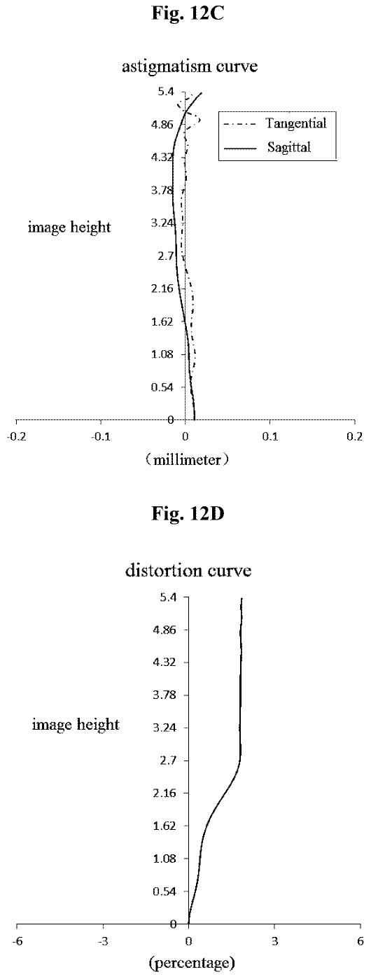

FIGS. 12A and 12C show astigmatism curves of the optical imaging lens assembly according to Embodiment 6 when the aperture value is 1.46 and 4.00 respectively to represent a tangential image surface curvature and a sagittal image surface curvature. FIGS. 12B and 12D show distortion curves of the optical imaging lens assembly according to Embodiment 6 when the aperture value is 1.46 and 4.00 respectively to represent distortion values corresponding to different image heights. According to FIGS. 12A-12D, it can be seen that the optical imaging lens assembly provided in Embodiment 6 may achieve high imaging quality.

From the above, Embodiment 1 to Embodiment 6 satisfy relationships shown in Table 13 respectively.

TABLE 13

| Conditional | | | | | | |
|---|---|---|---|---|---|---|
| expression/embodiment | 1 | 2 | 3 | 4 | 5 | 6 |
| f/(EPDmax − EPDmin) | 5.21 | 5.10 | 5.04 | 5.04 | 5.20 | 2.29 |
| EPDmax/EPDmin | 1.39 | 1.40 | 1.41 | 1.41 | 1.39 | 2.74 |
| f1/(R2 − R1) | 4.64 | 0.53 | 0.83 | 0.84 | 4.35 | 1.16 |
| R3/R4 | 1.03 | 1.63 | 1.85 | 1.84 | 1.05 | 1.61 |
| (R14 − R13)/f7 | 1.31 | 1.02 | 1.08 | 1.08 | 1.30 | 1.09 |
| f8/(T78 + CT8) | −3.32 | −3.29 | −3.40 | −3.39 | −3.32 | −3.35 |
| f123/f67 | 1.45 | 1.66 | 1.57 | 1.56 | 1.45 | 1.50 |
| f45/(R7 + R8 + | −0.48 | −1.90 | −0.56 | −0.58 | −0.48 | −0.62 |
| R9 + R10) | | | | | | |
| (CT1 + CT2 + CT3)/ | 1.81 | 1.63 | 1.70 | 1.71 | 1.81 | 1.68 |
| (ET1 + ET2 + ET3) | | | | | | |
| (ET4 + ET5)/ET6 | 1.91 | 1.45 | 1.14 | 1.14 | 1.87 | 1.26 |
| (SAG71 + SAG72)/ET7 | −2.61 | −1.82 | −1.84 | −1.83 | −2.60 | −1.75 |
| SAG81/SAG82 | 1.30 | 1.61 | 1.70 | 1.69 | 1.31 | 1.77 |
| f/(EPDmax − EPDmin) | 5.21 | 5.10 | 5.04 | 5.04 | 5.20 | 2.29 |

The disclosure also provides an imaging device, which may use a Charge-Coupled Device (CCD) or a Complementary Metal Oxide Semiconductor (CMOS) as an electronic photosensitive element, The imaging device may be an independent imaging device such as a digital camera, or may be an imaging module integrated into a mobile electronic device such, as a mobile phone. The imaging device is provided with the above-mentioned optical imaging lens assembly.

The above is only the description about the specific embodiments of the disclosure and adopted technical principles. It is understood by those skilled in the art that the scope of invention involved in the disclosure is not limited to the technical solutions formed by specifically combining the technical characteristics and should also cover other technical solutions formed by freely combining the technical characteristics or equivalent characteristics thereof without departing from the inventive concept, for example, technical solutions formed by mutually replacing the characteristics and (but not limited to) the technical characteristics with similar functions disclosed in the disclosure.

What is claimed is:

1., An optical imaging lens assembly, sequentially comprising, from an object side to an image side along an optical axis;
an iris diaphragm;
a first lens with a positive refractive power, an object-side surface thereof is a convex surface, and an image-side surface thereof is a concave surface:
a second lens with a refractive power;
a third lens with a refractive power;
a fourth lens with a refractive power;
a fifth lens with a refractive power;
a sixth lens with refractive power;
a seventh lens with a positive refractive power; and
an eighth lens with a negative refractive power,
wherein EPDₘₐₓ is a maximum entrance pupil diameter of the optical imaging lens assembly, EPDₘᵢₙ is a minimum entrance pupil diameter of the optical imaging lens assembly, and EPDₘₐₓ, EPDₘᵢₙ and a total effective focal length f of the optical imaging lens assembly satisfy: f/(EPDₘₐₓ−EPDₘᵢₙ)>2.2.

2. The optical imaging lens assembly according to claim 1, wherein an effective focal length f1 of the first lens, a curvature radius R1 of the object-side surface of the first lens and a curvature radius R2 of the image-side surface of the first lens satisfy: 0.3<f1/(R2−R1)<4.8.

3. The optical imaging lens assembly according to claim 1, wherein a curvature radius R3 of an object-side surface of the second lens and a curvature, radius R4 of an image-side surface of the second lens satisfy: 0.8<R3/R4<2 0.

4. The optical imaging lens assembly according to claim 1, wherein a curvature radius R13 of an object-side surface of the seventh lens, a curvature radius R14 of an image-side surface of the seventh lens and an effective focal length f7 of the seventh lens satisfy: 0.8<(R14−R13)f7<1.5.

5. The optical imaging lens assembly according to claim 1, wherein an effective focal length f8 of the eighth lens, a spacing distance T78 between the seventh lens and the eighth lens on the optical axis and a center thickness CT8 of the eighth lens on, the optical axis satisfy: −3.6<f8/(T78+CT8)<-3.0.

6. The optical imaging lens assembly according to claim 1, wherein f123 is a combined focal length of the first lens, the second lens and the third lens, f67 is a combined focal length of the sixth lens and the seventh lens, and f123 and f67 satisfy: 1.2<f123/67<1.8.

7. The optical imaging lens assembly according to claim 1, wherein f45 is a combined focal length of the fourth lens and the fifth lens, a curvature radius R7 of an object-side surface of the fourth lens, a curvature radius R8 of an image-side surface of the fourth lens, is a curvature radius R9 of an object-side of the fifth lens, is a curvature radius R10 of an image-side surface of the fifth lens and f45 satisfy: −2.0<f45/(R7+R8+R9+R10)<-0.2.

8. The optical imaging lens assembly according to claim 1, wherein a center thickness CT1 of the first lens on the optical axis, a center thickness CT2 of the second lens on the optical axis, a center thickness CT3 of the third lens on the optical axis, an edge thickness ET1 of the first lens, an edge thickness ET2 of the second lens and an edge thickness ET3 of the third lens satisfy: 1.5<(CT1+CT2+CT3)/(ET1+ET2+ET3)<2.0.

9. The optical imaging lens assembly according to claim 1, wherein an edge thickness ET4 of the fourth lens, an edge thickness ET5 of the fifth lens and an edge thickness ET6 of the sixth lens satisfy: 1.0<(ET4+ET5)/ET6<2.0.

10. The optical imaging lens assembly according to claim 1, wherein SAG71 is a distance from an intersection point of an object-side surface of the seventh lens and the optical axis to an effective radius vertex of the object-side surface of the seventh lens on the optical axis, SAG72 is a distance from an intersection point of an image-side surface of the seventh lens and the optical axis to an effective radius'vertex of the image-side surface of the seventh lens on the optical axis, and SAG71, SAG72 and an edge thickness ET7 of the seventh lens satisfy: −2.8<(SAG71+SAG72)/ET7<-1.6.

11. The optical imaging lens assembly according to claim 1, wherein SAG81 is a distance from an intersection point of an object-side surface of the eighth lens and the optical axis to an effective radius vertex of the object-side surface of the eighth lens on the optical axis, SAG82 is a distance from an intersection point of an image-side surface of the eighth lens and the optical axis to an effective radius vertex of the image-side surface of the eighth lens on the optical axis, and SAG81 and SAG82 satisfy: 1.2<SAG81/SAG82<1.9.

12. The optical imaging lens assembly according to claim 1, wherein EPDₘₐₓ and EPDₘᵢₙ satisfy: 1.1<EPDₘₐₓ/EPDₘᵢₙ<3.1.

13. The optical imaging lens assembly according to claim 1, wherein EPDₘₐₓ, EPDₘᵢₙ and the total effective focal length f of the optical imaging lens assembly satisfy: 2.2<f/(EPDₘₐₓ−EPDₘᵢₙ)<20.

14. The optical imaging lens assembly according to claim 1, wherein an object-side surface of the sixth lens is a convex surface, and an image-side surface of the sixth lens is a concave surface; an object-side surface of the seventh lens is a convex surface, and an image-side surface of the seventh lens is a concave surface.

15. An optical imaging lens assembly, sequentially comprising, from an object side to an image side along an optical axis:
an iris diaphragm;
a first lens with a positive refractive power, an object-side surface thereof is a convex surface, and an image-side surface thereof is a concave surface;
a second lens with a refractive power;
a third lens with a refractive power;
a fourth lens with a refractive power;
a fifth lens with a refractive power;
a sixth lens with a refractive power;
a seventh lens with a positive refractive power; and
an eighth lens with a negative refractive power,
wherein f123 is a combined focal length of the first lens, the second lens and the third lens, f67 is a combined focal length of the sixth lens and the seventh lens, and f123 and f67 satisfy: 1.2<f123/f67<1.8.

16. The optical imaging lens assembly according to claim 15, wherein an effective focal length f1 of the first lens, a curvature radius R1 of the object-side surface of the first lens and a curvature radius R2 of the image-side surface of the first lens satisfy: 0.3<f1/(R2−R1)<4.8

17. The optical imaging lens assembly according to claim 15, wherein a curvature radius R3 of an object-side surface of the second lens and a curvature radius R4 of an image-side surface of the second lens satisfy: 0.8<R3/R4<2.0.

18. The optical imaging lens assembly according to claim 15, wherein a curvature radius R13 of an object-side surface of the seventh lens, a curvature radius R14 of an image-side surface of the seventh lens and an effective focal length f7 of the seventh lens satisfy: 0.8<(R14−R13)07<1.5.

19. The optical imaging lens assembly according to claim 15, wherein an effective focal length f8 of the eighth lens, a spacing distance T78 between the seventh lens and the eighth lens on the optical axis and a center thickness CT8 of the eighth lens on the optical axis satisfy: −3.6<f8/(T78+CT8)<-3.0.

20. The optical imaging lens assembly according to claim 15, wherein f45 is a combined focal length of the fourth lens and the fifth lens, a curvature radius R7 of an object-side surface of the fourth lens, a curvature radius R8 of an image-side surface of the fourth lens, is a curvature radius R9 of an object-side of the fifth lens, is a curvature radius R10 of an image-side surface of the fifth lens and f45 satisfy: −2.0<f45/(R7+R8+R9+R10)<-0.2.
